(19) United States
(12) Patent Application Publication
(10) Pub. No.: US 2026/0049684 A1
(43) Pub. Date: Feb. 19, 2026

(54) BEARING DEVICE AND TERMINAL HOLDER

(71) Applicant: SHENZHEN HAOHUALIANHE TECHNOLOGY CO.,LTD., Shenzhen (CN)

(72) Inventor: Weihao CHEN, Shenzhen (CN)

(21) Appl. No.: 19/367,017

(22) Filed: Oct. 23, 2025

Related U.S. Application Data
(63) Continuation of application No. PCT/CN2024/089384, filed on Apr. 23, 2024.

(30) Foreign Application Priority Data
Apr. 23, 2023 (CN) 202320953688.X
Apr. 23, 2023 (CN) 202320976303.1
Apr. 23, 2023 (CN) 202320996732.5

(51) Int. Cl. F16M 11/10; F16M 11/24; H04M 1/04

(52) U.S. Cl. CPC F16M 11/10; F16M 11/24; H04M 1/04

(57) ABSTRACT

A bearing device and a terminal holder, for bearing an electronic terminal and including a bearing body and two clamping members. The bearing body is arranged with a magnetic member. The clamping members are arranged on the bearing body to clamp the electronic terminal. At least one clamping member is a first clamping member, which is rotatably connected to the bearing body. When the bearing device clamps the electronic terminal, the first clamping member is disposed at a first position relative to the bearing body; the first clamping member can move to a second position relative to the bearing body and can be maintained at the second position. When the two clamping members clamp the electronic terminal, the magnetic member can magnetically attract the electronic terminal. When the first clamping member is at the second position, the electronic terminal can be smoothly placed on the bearing body.

### CROSS-REFERENCE TO RELATED APPLICATIONS

The present application is a continuation-application of International (PCT) Patent Application No. PCT/CN2024/089384, filed on Apr. 23, 2024, which claims priority of Chinese Patent Application No. 202320953688.X, filed on Apr. 23, 2023, Chinese Patent Application No. 202320996732.5, filed on Apr. 23, 2023, and Chinese Patent Application No. 202320976303.1, filed on Apr. 23, 2023, in the China National Intellectual Property Administration. The entire contents of International (PCT) Patent Application No. PCT/CN2024/089384, Chinese Patent Application No. 202320953688.X, Chinese Patent Application No. 202320996732.5, Chinese Patent Application No. 202320976303.1 are hereby incorporated by reference in their entireties.

### TECHNICAL FIELD

The present disclosure relates to the technical field of auxiliary supplies for electronic terminals, and in particular, to a bearing device and a terminal holder.

### BACKGROUND

Currently, mobile phones, tablets, e-readers, and other electronic terminals have become indispensable in everyone's daily life. To facilitate more convenient use of these electronic terminals, terminal holders have emerged accordingly.

A terminal holder typically includes a support device and a bearing device. The bearing device is arranged on the support device for carrying an electronic terminal. The support device can be positioned on the ground, a desktop, a specific object, etc.

For some kinds of existing terminal holders, the bearing device can magnetically attract the electronic terminal, which is very convenient for users to place or remove the terminal from the bearing device. However, when the electronic terminal is too heavy, or when the terminal holder is used under dynamic conditions, the electronic terminal is prone to falling off the bearing device.

### SUMMARY OF THE DISCLOSURE

In view of the defects and shortcomings of the related art, a first object of the present disclosure is to provide a bearing device.

The present invention proposes a bearing device, configured to bear an electronic terminal and including a bearing body and two clamping members;

where the bearing body is arranged with a magnetic member for magnetically attracting the electronic terminal;

the two clamping members are both arranged on the bearing body, and the two clamping members are configured to cooperate to clamp the electronic terminal;

at least one of the two clamping members is a first clamping member, and the first clamping member is rotatably connected to the bearing body; in a case where the bearing device clamps the electronic terminal, first clamping member is disposed at a first position relative to the bearing body; the first clamping member is capable of moving to a second position relative to the bearing body, and the first clamping member is capable of being maintained at the second position relative to the bearing body;

where, in a case where the two clamping members clamp the electronic terminal, the magnetic member is configured to magnetically attract the electronic terminal; in a case where the first clamping member is at the second position relative to the bearing body, the electronic terminal is capable of being smoothly placed on the bearing body, causing the magnetic member to magnetically attract the electronic terminal.

In some embodiments, the bearing body includes a first limiting portion corresponding to each first clamping member, and the first clamping member includes a second limiting portion adapted to the first limiting portion;

during a process where the first clamping member moves from the first position to the second position, the second limiting portion and the first limiting portion transition from a disengaged state to an engaged state, and the second limiting portion and the first limiting portion being in the engaged state enables the first clamping member to be maintained at the second position relative to the bearing body;

during a process where the first clamping member moves from the second position to the first position, the second limiting portion and the first limiting portion transition from the engaged state to the disengaged state.

In some embodiments, the bearing body includes a first main body, and the bearing body further includes a first slidable member and a first elastic element corresponding to the first clamping member;

the first slidable member is slidably arranged on the first main body, and the first limiting portion is arranged on the first slidable member; an end of the first elastic element acts on the first main body, and another end of the first elastic element acts on the first slidable member; the first elastic element is configured to cause the first slidable member to abut against the first clamping member;

where in a case where the first clamping member is at the second position relative to the bearing body, the first elastic element causes the first limiting portion and the second limiting portion to be in the engaged state;

during a process where the first limiting portion and the second limiting portion transition from the engaged state to the disengaged state or from the disengaged state to the engaged state, the first slidable member slides relative to the first clamping member.

In some embodiments, the first limiting portion is a first groove, and the second limiting portion is a first protrusion; or, the first limiting portion is a first protrusion, and the second limiting portion is a first groove;

the first protrusion is engaged in the first groove to achieve the engaged state between the first limiting portion and the second limiting portion.

In some embodiments, the first groove has a first opening; a cross-section of the first groove increases from a bottom wall of the first groove to the first opening.

In some embodiments, the first groove extends in a direction parallel to a first straight line, and the cross-section of the first groove is V-shaped; the first protrusion is cylindrical; in a case where the first limiting portion and the second limiting portion are in the engaged state, an extending direction of the first protrusion is parallel to the first straight line.

In some embodiments, the first clamping member is rotatably arranged on the bearing body about a first axis, the first slidable member is slidably arranged on the first main body in a direction parallel to the first axis, and the first slidable member is peripherally fixed relative to the first main body about the first axis;

the first clamping member is slidably arranged on the bearing body in the direction parallel to the first axis, and the first elastic element is configured to cause the first slidable member to abut against the first clamping member;

where in a case where the bearing device is not clamping the electronic terminal, the first elastic element is configured to cause the first slidable member to abut against the first clamping member, causing the first clamping member to be retracted into the bearing body; in a case where the first clamping member extends relative to the bearing body, the first elastic element is configured to cause the first slidable member to abut against the first clamping member, causing the first clamping member to have a clamping force for clamping the electronic terminal;

the first elastic element and the first slidable member are configured to enable the first clamping member to be elastically retractable in the direction parallel to the first axis; in a case where the first clamping member extends or retracts relative to the bearing body, a clamping width of the bearing device is changeable.

In some embodiments, the first clamping member is rotatably arranged on the first slidable member about the first axis, causing the first clamping member to be rotatably arranged on the bearing body about the first axis;

during a process where the first limiting portion and the second limiting portion transition from the disengaged state to the engaged state or from the engaged state to the disengaged state, the first slidable member slides relative to the first clamping member in the direction parallel to the first axis;

during a process where the first clamping member extends or retracts relative to the bearing body, the first slidable member always follows the first clamping member, causing the first clamping member to slide relative to the bearing body in the direction parallel to the first axis.

In some embodiments, the first clamping member includes a first clamping portion and a rotating connection portion; the first clamping portion is configured to clamp the electronic terminal, the first clamping portion is arranged on the rotating connection portion, and the second limiting portion is arranged on the rotating connection portion;

the first slidable member defines a first connection hole, the rotating connection portion is sleeved in the first connection hole, and the rotating connection portion is rotatable relative to the first connection hole about the first axis, causing the first clamping member to be rotatably connected to the bearing body about the first axis;

during the process where the first limiting portion and the second limiting portion transition from the disengaged state to the engaged state or from the engaged state to the disengaged state, the first connection hole slides relative to the rotating connection portion in the direction parallel to the first axis; during a process where the first clamping member slides relative to the bearing body in the direction parallel to the first axis, the first slidable member always follows the rotating connection portion.

In some embodiments, the first limiting portion is a first groove, the second limiting portion is a first protrusion, the first protrusion is engaged in the first groove to achieve the engaged state between the first limiting portion and the second limiting portion, and the first protrusion protrudes from the rotating connection portion;

where in a case where the first clamping member extends relative to the bearing body, the first protrusion pushes the first slidable member, causing the first slidable member to slide relative to the first main body; in a case where the first clamping member retracts relative to the bearing body, the first elastic element pushes the first slidable member, causing the first slidable member slides relative to the first main body.

In some embodiments, the first elastic element is a first spring, the first spring is helical, and the first spring surrounds the rotating connection portion;

the first main body defines a first sliding groove corresponding to the first clamping member, the first slidable member is slidably arranged in the first sliding groove, and the first spring is accommodated in the first sliding groove.

In some embodiments, the first main body defines a second connection hole corresponding to the first clamping member, and the second connection hole is coaxial with the first connection hole; the rotating connection portion is slidable relative to the second connection hole in the direction parallel to the first axis, and the rotating connection portion is rotatable relative to the second connection hole about the first axis.

In some embodiments, the first main body has a first wall body corresponding to the first clamping member, and the first wall body is spaced apart from the first slidable member; the first elastic element is disposed between the first wall body and the first slidable member; an end of the first elastic element acts on the first wall body, and another end of the first elastic element acts on the first slidable member; the second connection hole is defined on the first wall body.

In some embodiments, the first elastic element is a first spring, the first spring is helical, and the first spring surrounds the rotating connection portion;

the first main body defines a first sliding groove corresponding to the first clamping member, the first slidable member is slidably arranged in the first sliding groove, and the first elastic element is accommodated in the first sliding groove;

the first spring is a compression spring, and in a case where the first clamping member extends relative to the bearing body, the first slidable member moves closer to the first wall body.

In some embodiments, the bearing body includes a third limiting portion corresponding to the first clamping member, and the second limiting portion is adapted to the third limiting portion;

the first clamping member is rotatably arranged on the bearing body about a first axis, and the first clamping member is elastically retractable relative to the bearing body in a direction parallel to the first axis; an elastic retractability of the first clamping member relative to the bearing body is capable of changing a clamping width of the bearing device;

the first clamping member is capable of rotating from the second position to a first ready-to-clamp position relative to the bearing body, and the first clamping member is capable of extending from the first ready-to-clamp position to the first position; in a case where the first clamping member is at the first ready-to-clamp position relative to the bearing body, the first clamping member is retracted into the bearing body;

during a process where the first clamping member rotates from the second position to the first ready-to-clamp position, the second limiting portion and the third limiting portion transition from a disengaged state to an engaged state, and the second limiting portion and the third limiting portion being in the engaged state enables the first clamping member to be maintained at the first ready-to-clamp position relative to the bearing body;

during a process where the first clamping member rotates from the first ready-to-clamp position to the second position, the third limiting portion and the second limiting portion transition from the engaged state to the disengaged state.

In some embodiments, the bearing body includes a first main body, and the bearing body further includes a first slidable member and a first elastic element corresponding to the first clamping member;

the first slidable member is slidably arranged on the first main body, the first limiting portion is arranged on the first slidable member, and the third limiting portion is arranged on the first slidable member; an end of the first elastic element acts on the first main body, and another end of the first elastic element acts on the first slidable member; the first elastic element is configured to cause the first slidable member to abut against the first clamping member;

where in a case where the first clamping member is at the second position relative to the bearing body, the first elastic element causes the first limiting portion and the second limiting portion to be in the engaged state;

in a case where the first clamping member is at the first ready-to-clamp position relative to the bearing body, the first elastic element causes the third limiting portion to engage with the second limiting portion;

during a process where the first limiting portion and the second limiting portion transition from the engaged state to the disengaged state or from the disengaged state to the engaged state, the first slidable member slides relative to the first clamping member;

during a process where the third limiting portion and the second limiting portion transition from the engaged state to the disengaged state or from the disengaged state to the engaged state, the first slidable member slides relative to the first clamping member.

In some embodiments, the first clamping member includes a first clamping portion and a rotating connection portion; the first clamping portion is configured to clamp the electronic terminal, and the first clamping portion is arranged on the rotating connection portion;

the rotating connection portion is rotatably arranged on the bearing body about the first axis, and the second limiting portion is arranged on the rotating connection portion.

In some embodiments, the first limiting portion is a first groove, the third limiting portion is a second groove, and the second limiting portion is a first protrusion;

the first protrusion is engaged in the first groove to achieve the engaged state between the second limiting portion and the first limiting portion, and the first protrusion is engaged in the second groove to achieve the engaged state between the second limiting portion and the third limiting portion.

In some embodiments, the first groove has a first opening; a cross-section of the first groove increases from a bottom wall of the first groove to the first opening; the second groove has a second opening; a cross-section of the second groove increases from a bottom wall of the second groove to the second opening;

the first groove extends in a direction parallel to a first straight line, and the cross-section of the first groove is V-shaped; the first protrusion is cylindrical; in a case where the first limiting portion and the second limiting portion are in the engaged state, an extending direction of the first protrusion is parallel to the first straight line;

the second groove extends in a direction parallel to a second straight line, the first groove and the second groove intersect, and the cross-section of the second groove is V-shaped; in a case where the second limiting portion and the third limiting portion are in the engaged state, an extending direction of the first protrusion is parallel to the second straight line.

In some embodiments, during a process where the first clamping member slides from the first ready-to-clamp position to the first position, the second limiting portion and the third limiting portion remain in the engaged state.

In some embodiments, the bearing body includes a first positioning portion corresponding to each first clamping member, and the first clamping member includes a second positioning portion adapted to the first positioning portion;

during a process where the first clamping member moves from the first position to the second position, the second positioning portion and the first positioning portion transition from a disengaged state to an engaged state, and the first positioning portion and the second positioning portion being in the engaged state enables the first clamping member to be maintained at the second position relative to the bearing body;

during a process where the first clamping member moves from the second position to the first position, the second positioning portion and the first positioning portion transition from the engaged state to the disengaged state.

In some embodiments, the first positioning portion comprises at least one second protrusion, and the second positioning portion comprises at least one third groove; or, the first positioning portion comprises at least one third groove, and the second positioning portion comprises at least one second protrusion;

each of the at least one second protrusion is engaged in a corresponding third groove to achieve the engaged state between the second positioning portion and the first positioning portion.

In some embodiments, the first clamping member is rotatably arranged on the bearing body about a first axis, and the first clamping member is elastically retractable relative to the bearing body in a direction parallel to the first axis; an elastic retractability of the first clamping member relative to the bearing body is capable of changing a clamping width of the bearing device; in a case where the first clamping member is at the second position relative to the bearing body, the first clamping member is retracted into the bearing body;

the at least one second protrusion is two second protrusions, and the at least one third groove is two third grooves; the two second protrusions are disposed on opposite sides of the first axis, and the two third grooves are disposed on opposite sides of the first axis;

the second protrusion has two first side walls, and a distance between the two first side walls narrows from a bottom end to a top end of the second protrusion; during a process where the first clamping member rotates into or out of the second position relative to the bearing body, the first clamping member slides over the first side walls.

In some embodiments, the first clamping member includes a third positioning portion, and the third positioning portion is adapted to the first positioning portion;

the first clamping member is rotatably arranged on the bearing body about a first axis, and the first clamping member is elastically retractable relative to the bearing body in a direction parallel to the first axis; an elastic retractability of the first clamping member relative to the bearing body is capable of changing a clamping width of the bearing device; in a case where the first clamping member is at the second position relative to the bearing body, the first clamping member is retracted into the bearing body;

the first clamping member is capable of rotating from the second position to a first ready-to-clamp position relative to the bearing body, and the first clamping member is capable of extending from the first ready-to-clamp position to the first position;

during a process where the first clamping member is rotated from the second position to the first ready-to-clamp position, the first positioning portion and the third positioning portion transition from a disengaged state to an engaged state, and the first positioning portion and the third positioning portion being in the engaged state enables the first clamping member to be maintained at the first ready-to-clamp position relative to the bearing body;

during a process where the first clamping member is rotated from the first ready-to-clamp position to the second position, the first positioning portion and the third positioning portion transition from the engaged state to the disengaged state.

In some embodiments, the first positioning portion comprises at least one second protrusion, the second positioning portion comprises at least one third groove, and the third positioning portion comprises at least one fourth groove; each of the at least one second protrusion is engaged in a corresponding third groove to achieve the engaged state between the first positioning portion and the second positioning portion; each of the at least one second protrusion is engaged in a corresponding fourth groove to achieve the engaged state between the first positioning portion and the third positioning portion;

the at least one second protrusion is two second protrusions, the at least one third groove is two third grooves, and the at least one fourth groove is two fourth grooves; the two second protrusions are disposed on opposite sides of the first axis, the two third grooves are disposed on opposite sides of the first axis, and the two fourth grooves are disposed on opposite sides of the first axis;

each second protrusion has two first side walls, and a distance between the two first side walls narrows from a bottom end to a top end of the second protrusion; during a process where the first clamping member rotates into or out of the second position relative to the bearing body, the first clamping member slides over the first side walls; during a process where the first clamping member rotates into or out of the first ready-to-clamp position relative to the bearing body, the first clamping member slides over the first side walls.

In some embodiments, in a case where the first clamping member is at the second position relative to the bearing body and the magnetic member magnetically attracts the electronic terminal, the first clamping member and the bearing body are disposed on a same side of the electronic terminal.

In some embodiments, the bearing body has a first peripheral wall corresponding to each first clamping member, and the bearing body has a first peripheral space adjacent to the first peripheral wall; the first clamping member includes a rotating connection portion and a first clamping portion, where the rotating connection portion is rotatably arranged on the bearing body, the first clamping portion is arranged on the rotating connection portion, and the first clamping portion is rotatably arranged on the bearing body; the first clamping portion is configured to clamp the electronic terminal, and in a case where the first clamping member is at the second position relative to the bearing body, the first clamping portion is disposed in the first peripheral space of the bearing body.

In some embodiments, in a case where the first clamping member is at the second position relative to the bearing body, the first clamping portion is stacked on the first peripheral wall;

the first clamping portion has a first abutting wall; in a case where the first clamping portion clamps the electronic terminal, the first abutting wall abuts against the electronic terminal; in a case where the first clamping member is at the second position relative to the bearing body, the first abutting wall is close to or attached to the first peripheral wall of the bearing body.

In some embodiments, the rotating connection portion is rotatably arranged on the bearing body about a first axis;

the first peripheral wall includes a first sub-wall and a second sub-wall, and the first sub-wall and the second sub-wall are disposed on opposite sides of the first axis;

in a case where the first clamping member is at the second position relative to the bearing body, the first abutting wall is capable of being close to or attached to the first sub-wall of the bearing body, or the first abutting wall is capable of being close to or attached to the second sub-wall of the bearing body.

In some embodiments, the rotating connection portion is rotatably arranged on the bearing body about a first axis, and the rotating connection portion is elastically retractable relative to the bearing body in a direction parallel to the first axis;

the first abutting wall is adapted to the first peripheral wall, and in a case where the first clamping member is at the second position relative to the bearing body, the first abutting wall is attached to the first peripheral wall.

In some embodiments, both the two clamping members are the first clamping members, a first plane perpendicular to a clamping direction of the two clamping members is defined, and the first plane is disposed between the two clamping members;

in a case where the first clamping member is at the first position relative to the bearing body, a bottom end of the first abutting wall is close to the bearing body, a top end of the first abutting wall is away from the bearing body, and from the bottom end to the top end of the first abutting wall, the first abutting wall gradually approaches the first plane.

In some embodiments, both the two clamping members are the first clamping members.

The present disclosure further provides a terminal holder, including a supporting device and the bearing device as above; where the bearing device is arranged on the supporting device.

By implementing the aforementioned bearing device, the bearing body of the bearing device is arranged with a magnetic member and two clamping members. When the electronic terminal is too heavy (or when the bearing device is used in a moving state), the magnetic member can magnetically attract the electronic terminal, and the two clamping members cooperate to clamp the electronic terminal. The two clamping members can assist in stabilizing the electronic terminal, keeping it stably positioned on the bearing device, thereby preventing the electronic terminal from falling off the bearing device when it is too heavy, or preventing the electronic terminal from falling off the bearing device during movement. Furthermore, when the first clamping member is at the second position relative to the bearing body, the electronic terminal can be smoothly placed on the bearing body without adjusting the position of the first clamping member, enabling the magnetic member to attract the electronic terminal. The electronic terminal can be freely placed on or removed from the bearing body without requiring the user to manually adjust the position of the first clamping member each time, thereby making operation more convenient and efficient, and avoiding the hassle of adjusting the position of the first clamping portion. Since the position of the first clamping member can be changed, when using the bearing device, in a case where both first clamping members are at the second position relative to the bearing body, the user can directly place the electronic terminal horizontally (i.e., the direction of a longer length of the electronic terminal is in a horizontal direction) on the bearing body without adjusting the position of the first clamping members, thus making usage more convenient.

### BRIEF DESCRIPTION OF THE DRAWINGS

To more clearly illustrate the technical solutions in the embodiments of the present disclosure or the related art, the drawings required for describing the embodiments or the related art will be briefly introduced below. Obviously, the drawings in the following description are only some embodiments of the present disclosure. For those skilled in the art, other drawings may be obtained based on these drawings without creative effort.

FIG. 1 is a structural schematic diagram of a bearing device according to some embodiments of the present disclosure.

FIG. 2 is a cross-sectional view of the bearing device shown in FIG. 1 along line A-A.

FIG. 3 is an enlarged view of the structure at position B in the bearing device shown in FIG. 2.

FIG. 4 is an enlarged view of the structure at position C in the bearing device shown in FIG. 2.

FIG. 5 is a state diagram of the bearing device shown in FIG. 1 when two first clamping members are both at a first clamping-ready position.

FIG. 6 is a structural schematic diagram of the bearing device shown in FIG. 5 with a first clamping portion hidden.

FIG. 7 is an enlarged view of the structure at position D in the structure shown in FIG. 6.

FIG. 8 is a structural schematic diagram of one of the first clamping portions in the bearing device shown in FIG. 5.

FIG. 9 is a structural schematic diagram of the structure shown in FIG. 6 with a first housing hidden.

FIG. 10 is a schematic diagram of the cooperation between a rotating connection portion and a first sliding part in the structure shown in FIG. 9.

FIG. 11 is a structural schematic diagram of the first sliding part in the structure shown in FIG. 10.

FIG. 12 is a structural schematic diagram of a second housing in the structure shown in FIG. 6.

FIG. 13 is a structural schematic diagram of the first housing in the structure shown in FIG. 6.

FIG. 14 is a structural schematic diagram of a first magnetic member in the structure shown in FIG. 6.

FIG. 15 is a state diagram of the bearing device shown in FIG. 1 when two first clamping members are both at a first position.

FIG. 16 is an enlarged view of the structure at position E in the bearing device shown in FIG. 15.

FIG. 17 is a state diagram of the bearing device shown in FIG. 1 when one of the first clamping members is at a second position.

FIG. 18 is a structural schematic diagram of a terminal holder according to some embodiments of the present disclosure.

### DETAILED DESCRIPTION

The present disclosure will be further described in detail below with reference to the drawings.

Specific embodiments of the present disclosure are only intended to provide an explanation of the present disclosure and not a limitation of the present disclosure. After reading this specification, those skilled in the art can make modifications to the embodiments without creative contribution as needed, but as long as they are within the scope of the claims of the present disclosure, they are protected by patent law.

In the description of the present disclosure, it should be understood that terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “peripheral”, etc. indicate orientations or positional relationships based on the orientations or positional relationships shown in the drawings. They are only for the convenience of describing the present disclosure and simplifying the description, and do not indicate or imply that the referred device or element must have a specific orientation, be constructed and operated in a specific orientation. Therefore, they cannot be understood as limitations on the present disclosure.

Furthermore, terms “first” and “second” are used for descriptive purposes only and cannot be understood as indicating or implying relative importance or implicitly indicating the number of technical features referred to. Thus, features defined with “first” and “second” may explicitly or implicitly include at least one of the features. In the description of the present disclosure, “a multiple” means at least two, such as two, three, etc., unless otherwise specifically defined.

In the present disclosure, unless otherwise explicitly specified and defined, terms such as “install”, “connect”, “link”, and “fix” should be understood broadly. For example, it may be a fixed connection, a detachable connection, or an integrated connection; it may be a mechanical connection, an electrical connection, or a communication connection; it may be a direct connection, or an indirect connection through an intermediate medium, it may be the internal connection of two elements or the interaction relationship between two elements, unless otherwise explicitly defined. For those skilled in the art, the specific meanings of the above terms in the present disclosure can be understood based on specific situations.

In the present disclosure, unless otherwise explicitly specified and defined, a first feature being “on” or “under” a second feature may mean that the first and second features are in direct contact, or that the first and second features are in indirect contact through an intermediate medium. Moreover, the first feature being “above”, “over” or “on” the second feature may mean that the first feature is directly above or obliquely above the second feature, or simply that the first feature is at a higher level than the second feature. The first feature being “below”, “under” or “beneath” the second feature may mean that the first feature is directly below or obliquely below the second feature, or simply that the first feature is at a lower level than the second feature.

It should be noted that when an element is referred to as being “fixed to” or “disposed on” another element, it may be directly on the other element or there may be an intervening element. When an element is considered to be “connected” to another element, it may be directly connected to the other element or there may be intervening elements at the same time. The terms “vertical”, “horizontal”, “upper”, “lower”, “left”, “right” and similar expressions used herein are for illustrative purposes only and do not represent the only implementation.

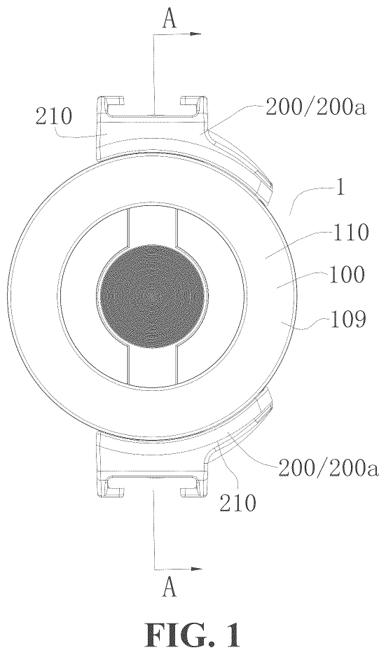

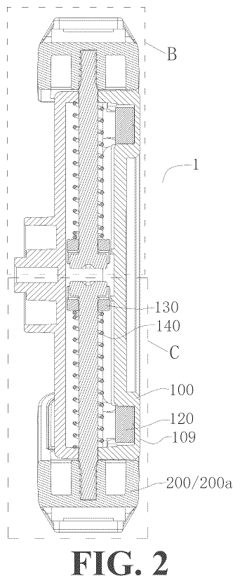

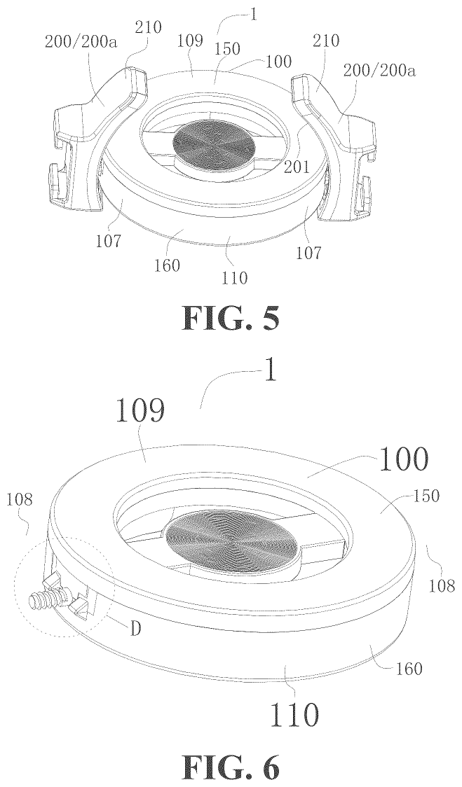

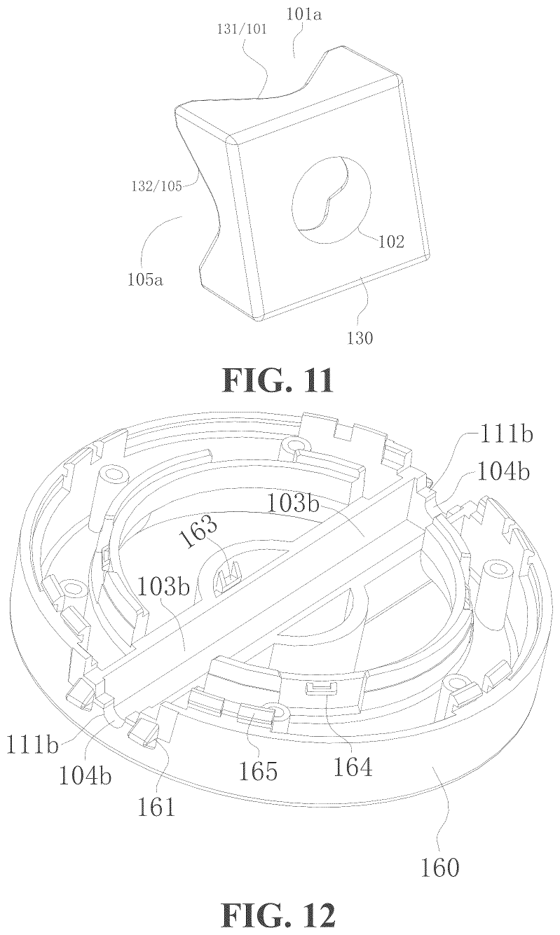

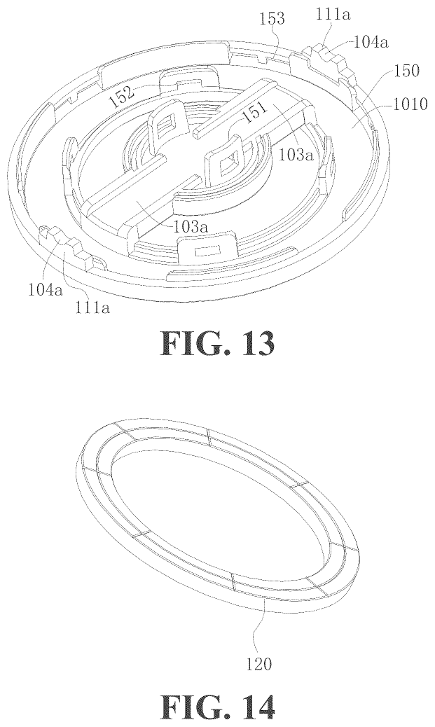

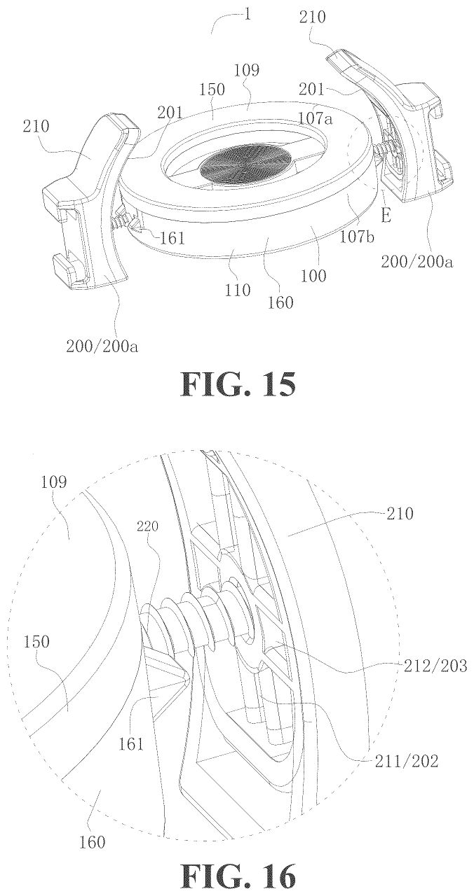

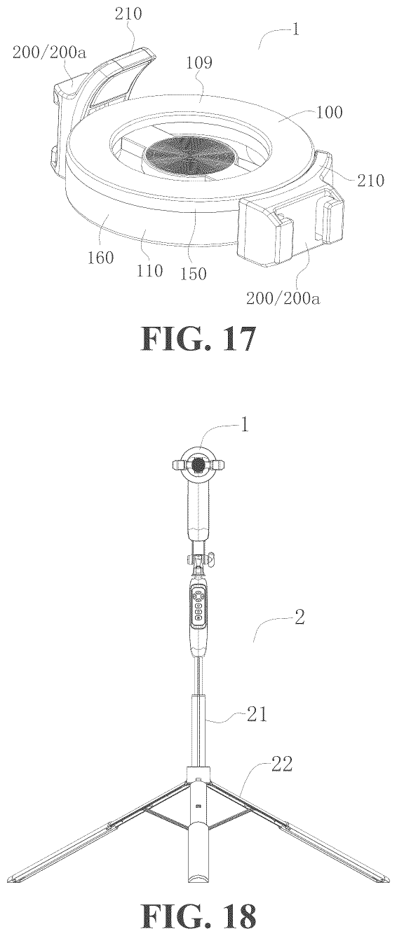

Referring to FIGS. 1-17, some embodiments of the present disclosure provide a bearing device 1, configured to bear an electronic terminal and including a bearing body 100 and two clamping members 200. The bearing body 100 is arranged with a magnetic member 120 for magnetically attracting the electronic terminal. The two clamping members 200 are arranged on the bearing body 100, and the two clamping members 200 are configured to cooperate to clamp the electronic terminal. At least one of the two clamping members 200 is a first clamping member 200a. The first clamping member 200a is rotatably connected to the bearing body 100. When the bearing device 1 clamps the electronic terminal, the first clamping member 200a is at a first position relative to the bearing body 100. The first clamping member 200a can move to a second position relative to the bearing body 100, and the first clamping member 200a can be maintained at the second position relative to the bearing body 100. When the two clamping members 200 clamp the electronic terminal, the magnetic member 120 can magnetically attract the electronic terminal. When the first clamping member 200a is at the second position relative to the bearing body 100, the electronic terminal can be smoothly placed on the bearing body 100 such that the magnetic member 120 magnetically attracts the electronic terminal.

In the above embodiments, the bearing body 100 of the bearing device 1 is arranged with the magnetic member 120 and further arranged with the two clamping members 200. When the electronic terminal is too heavy (or when the bearing device 1 is required to be used in a moving state), the magnetic member 120 magnetically attracts the electronic terminal, and the two clamping members 200 cooperate to clamp the electronic terminal. The two clamping members 200 can play an auxiliary role in stabilizing the electronic terminal, keeping the electronic terminal stably disposed on the bearing device 1, thereby preventing the electronic terminal from falling off the bearing device 1 when it is too heavy, or preventing the electronic terminal from falling off the bearing device 1 when the bearing device 1 is moving. When the electronic terminal is lighter (or when the bearing device 1 is only used in a stationary state), the first clamping member 200a may be moved to the second position of the bearing body 100, such that the user can directly place the electronic terminal on the bearing body 100 for the magnetic member 120 to magnetically attract the electronic terminal. Moreover, after the first clamping member 200a is adjusted to the second position of the bearing body 100, the electronic terminal can be freely placed or taken out from the bearing body 100 without the user having to manually adjust the position of the first clamping member 200a each time, thereby making the operation more convenient and quicker, and avoiding the trouble of adjusting the position of the first clamping portion 210.

It can be understood that when the electronic terminal does not have a corresponding magnetic portion, or when the magnetic portion of the electronic terminal is not arranged on the bearing device 1 corresponding to the magnetic member 120, the two clamping portions of the bearing device 1 can still clamp the electronic terminal.

It can be understood that the first clamping member 200a is rotatable relative to the bearing body 100, and the first clamping member 200a can be disposed at the second position of the bearing body 100, such that the bearing device 1 has three use modes: a magnetic attraction use mode, a clamping magnetic attraction use mode, and a clamping use mode.

It can be understood that when the bearing device 1 clamps the electronic terminal, the bearing device 1 may be a kind of fixture 1.

It can be understood that the first clamping member 200a is rotatable relative to the bearing body 100, which further facilitates the storage of the bearing device 1. For example, when it is necessary to store the bearing device 1 or a terminal holder including the bearing device 1, the position of the first clamping member 200a can be adjusted such that the bearing device 1 enters a suitable storage posture, thereby facilitating the storage of the bearing device 1 or the terminal holder.

It can be understood that the magnetic member 120 may be a magnetic ring built into the bearing body 100. The magnetic member 120 includes various permanent magnets and electromagnets with magnetic attraction functions. The permanent magnets are made of permanent magnet materials, which may be, for example, ferrite, neodymium iron boron, magnetite, etc. The magnetic member 120 can achieve the function of magnetically attracting the electronic terminal. The type of magnetic member 120 is not limited herein.

It can be understood that when the clamping member 200 is at the first position relative to the bearing body 100, the clamping member 200 protrudes from the bearing body 100, such that the two clamping members 200 can cooperate to clamp the electronic terminal. The bearing body 100 has a bearing surface 109. When the electronic terminal is placed on the bearing body 100, the bearing surface 109 bears the electronic terminal. When the clamping member 200 is at the first position relative to the bearing body 100, the first clamping member 200a protrudes from the bearing surface 109.

It can be understood that when the first clamping member 200a is at the first position relative to the bearing body 100, the first clamping member 200a protrudes from the bearing body 100, such that the two clamping members 200 can cooperate to clamp the electronic terminal. The bearing body 100 has the bearing surface 109. When the electronic terminal is placed on the bearing body 100, the bearing surface 109 bears the electronic terminal. When the first clamping member 200a is at the first position relative to the bearing body 100, the first clamping member 200a protrudes from the bearing surface 109.

It can be understood that when the first clamping member 200a is at the second position relative to the bearing body 100, the first clamping member 200a does not hinder the placement of the electronic terminal on the bearing body 100, such that the electronic terminal can be smoothly placed on the bearing body 100. For example, when the first clamping member 200a is at the second position relative to the bearing body 100, the first clamping member 200a does not protrude from the bearing surface 109 of the bearing body 100. For example, the first clamping member 200a is on a back surface of the bearing body 100, or the first clamping member 200a is on a side wall of the bearing body 100, or the bearing body 100 defines a storage groove, and the first clamping member 200a can be stored in the storage groove. The bearing surface 109 of the bearing body 100 is a surface that contacts the electronic terminal, and a surface of the bearing body 100 away from the bearing surface 109 is the back surface. When the first clamping member 200a is at the first position, it can assist the bearing body 100 to clamp the electronic terminal more stably.

For example, when the first clamping member 200a is at the second position relative to the bearing body 100, the first clamping member 200a is disposed in a side space of the bearing body 100.

For example, when the first clamping member 200a is at the second position relative to the bearing body 100, the first clamping member 200a is stacked on the bearing body 100. For example, the first clamping member 200a is stacked on a first peripheral wall 107 of the bearing body 100.

It can be understood that the position mentioned in the embodiments of the present disclosure may be a point or a range. A position of A relative to B may refer to one or more points of A relative to B. When A is at a point relative to B, the form of the whole composed of A and B remains unchanged. The position of A relative to B may refer to a range of positions of A relative to B. When A is within the range of positions relative to B, the form of the whole composed of A and B may change.

For example, the first position may refer to one or more first position points. When the first clamping member 200a is at the first position point of the bearing body 100, it cooperates with the other first clamping member 200 to clamp the electronic terminal. The first position may refer to a first position range. When the first clamping member 200a is within the first position range of the bearing body 100, it can clamp the electronic terminal. For example, after the first clamping member 200a moves relative to the bearing body 100 within the first position range, it can still clamp the electronic terminal.

For example, the second position may refer to one or more second position points of the first clamping member 200a relative to the bearing body 100. When the first clamping member 200a is at the second position point relative to the bearing body 100, the first clamping member 200a is fixed relative to the bearing body 100. The second position may refer to a second position range of the first clamping member 200a relative to the bearing body 100. When the first clamping member 200a is within the second position range relative to the bearing body 100, the electronic terminal can be smoothly placed on the bearing body 100. For example, after the first clamping member 200a moves relative to the bearing body 100 within the first position range, it may still not hinder the placement of the electronic terminal on the bearing body 100.

It can be understood that the first clamping member 200a can be maintained at the second position relative to the bearing body 100, which may mean that the first clamping member 200a is maintained at one or more second position points relative to the bearing body 100, or may mean that the first clamping member 200a is maintained within the second position range relative to the bearing body 100.

For example, there are many ways for the first clamping member 200a to be maintained at the second position relative to the bearing body 100.

For example, there is rotational damping between the first clamping member 200a and the bearing body 100 such that the first clamping member 200a can be maintained at the second position relative to the bearing body 100. The first clamping member 200a and the bearing body 100 may be interference fitted (or a damping ring may be provided between the first clamping member 200a and the bearing body 100) such that there is rotational damping between the first clamping member 200a and the bearing body 100.

For another example, the bearing device 1 further includes a fastening member. The fastening member enables the first clamping member 200a to be maintained at the second position relative to the bearing body 100. The fastening member may be a first screw. The first screw is threadedly engaged with the first clamping member 200a. When the first clamping member 200a moves to the second position, rotating the first screw can make it abut against the bearing body 100, thereby keeping the first clamping member 200a at the second position relative to the bearing body 100. Alternatively, the first screw is threadedly engaged with the bearing body 100. Rotating the first screw can make it abut against the first clamping member 200a, thereby keeping the first clamping member 200a at the second position relative to the bearing body 100. Alternatively, the first screw is threadedly engaged with the first clamping member 200a. The bearing body 100 defines a limiting groove. When the first clamping member 200a moves to the second position, rotating the first screw can make it enter the limiting groove. The width of the limiting groove matches the first screw, such that the first clamping member 200a is kept at the second position point. Or, the width of the limiting groove is greater than the diameter of the first screw, such that the first clamping member 200a is kept within the second position range. Alternatively, the first screw is threadedly engaged with the bearing body 100. The first clamping member 200a defines a limiting groove. Rotating the first screw can make it enter the limiting groove, thereby keeping the first clamping member 200a at the second position.

For another example, the bearing device 1 includes a first snap structure. The first snap structure can make the first clamping member 200a snap to the bearing body 100 such that the first clamping member 200a can be maintained at the second position relative to the bearing body 100. For example, the first snap structure includes a first snap groove and a first snap protrusion. The first snap groove and the first snap protrusion are respectively provided on the first clamping member 200a and the bearing body 100 (or the first snap groove and the first snap protrusion are respectively provided on the bearing body 100 and the first clamping member 200a). The first snap protrusion can cooperate with the first snap groove to keep the first clamping member 200a at the second position of the bearing body 100. When the first snap protrusion matches the first snap groove, the first clamping member 200a can be kept at the second position point of the bearing body 100. When the width of the first snap groove is greater than the width of the first snap protrusion, the first clamping member 200a can be kept within the second position range of the bearing body 100.

It can be understood that after the first clamping member 200a is maintained at the second position relative to the bearing body 100, there is no need to adjust the position of the first clamping member 200a when the bearing device 1 clamps terminals such as mobile phones and tablets, thereby making the operation more convenient and time-saving.

It can be understood that after the first clamping member 200a is maintained at the second position relative to the bearing body 100, when swinging the bearing device 1 or moving the terminal holder, the first clamping member 200a can still be maintained at the second position relative to the bearing body 100.

For example, when the first clamping member 200a moves from the first position to the second position, the first clamping member 200a is required to rotate by a first angle. The first angle may be 90°, 75°, 60°, 45°, 135°, 150°, 165°, 270°, etc.

It can be understood that when the first clamping member 200a is at the second position, the bearing device 1 is in a non-clamping state. It can be understood that when the bearing device 1 clamps the electronic terminal, the bearing device 1 is in a clamping state. When the bearing device 1 does not clamp the electronic terminal, the bearing device 1 is in the non-clamping state.

For example, the first clamping member 200a has a rotational degree of freedom relative to the bearing body 100. For example, the first clamping member 200a has two rotational degrees of freedom relative to the bearing body 100. For example, a rotating connection portion 220 of the first clamping member 200a is rod-shaped, or the rotating connection portion 220 of the first clamping member 200a is spherical.

For example, the first clamping member 200a is only rotatably connected to the bearing body 100. In a clamping direction, the first clamping member 200a is not retractable relative to the bearing body 100. The first clamping member 200a can rotate from the first position to the second position.

For example, the first clamping member 200a is rotatably connected to the bearing body 100. In the clamping direction, the first clamping member 200a is retractable relative to the bearing body 100. When the first clamping member 200a is at the second position relative to the bearing body 100, the first clamping member 200a can be rotated by a first angle relative to the bearing body 100 and extended by a first distance, and then the first clamping member 200a is at the first position relative to the bearing body 100.

For example, the electronic terminal may be an electronic device such as a mobile phone or a tablet. The electronic terminal has a magnetic portion that can be magnetically attracted by the magnetic member 120. The magnetic portion may be made of permanent magnetic material or soft magnetic material. The soft magnetic material may be cast iron, low carbon steel, iron-silicon alloy, nickel-iron alloy, iron-cobalt alloy, etc.

It can be understood that there is a clamping width between the two clamping members 200 to facilitate the placement of the electronic terminal between the two clamping members 200.

For example, both the clamping members 200 are first clamping members 200a. Both the first clamping members 200a are rotatably arranged on the bearing body 100. For example, the two first clamping members 200a are respectively disposed on both sides of the bearing body 100.

For example, one of the two clamping members 200 is the first clamping member 200a. For example, the other clamping member 200 is movably arranged on the bearing body 100. For example, the other clamping member 200 is rotatably arranged on the bearing body 100, or the other clamping member 200 is slidably arranged on the bearing body 100. For example, the other clamping member 200 is fixedly arranged on the bearing body 100. For example, the other clamping member 200 is integrally connected to the bearing body 100.

It can be understood that when the two clamping members 200 clamp the electronic terminal, the bearing device 1 can elastically deform to provide the clamping force for clamping the electronic terminal.

For example, the first clamping member 200a is elastically retractable relative to the bearing body 100 to provide clamping force for the bearing device 1. For example, the first clamping member 200a is slidably arranged on the bearing body 100. An end of a first elastic element 140 acts on the first clamping member 200a, and the other end of the first elastic element 140 acts on the bearing body 100. The first elastic element 140 enables the first clamping member 200a to be elastically retractable relative to the bearing body 100.

For another example, one of the clamping members 200 is elastically retractable relative to the bearing body 100 to provide clamping force for the bearing device 1. For example, the clamping member 200 is slidably arranged on the bearing body 100. An end of an elastic element acts on the clamping member 200, and the other end of the elastic element acts on the bearing body 100. The elastic element enables the clamping member 200 to be elastically retractable relative to the bearing body 100.

For another example, both clamping members 200 are elastically retractable relative to the bearing body 100 to provide clamping force for the bearing device 1.

For another example, the bearing body 100 itself is elastically retractable to provide clamping force for the bearing device 1. For example, the bearing body 100 includes a first body, a second body, and a third elastic element. The second body is slidably arranged on the first body. An end of the third elastic element acts on the first body, and the other end of the third elastic element acts on the second body. The third elastic element enables the second body to be elastically retractable relative to the first body.

For another example, the first clamping member 200a itself is elastically retractable to provide clamping force for the bearing device 1.

For another example, one of the clamping members 200 itself is elastically retractable to provide clamping force for the bearing device 1, or both the clamping members 200 themselves are elastically retractable to provide clamping force for the bearing device 1.

For another example, the bearing device 1 can elastically deform to provide clamping force for the bearing device 1. For example, the first clamping member 200a can elastically deform; for example, the clamping member 200 can elastically deform; for example, the bearing body 100 can elastically deform.

It can be understood that when the first clamping member 200a is at the second position, the electronic terminal can be smoothly placed on the bearing body 100. This means that in the process of placing the electronic terminal on the bearing body 100 without obstruction, no adjustment of the bearing device 1 (such as adjusting the first clamping member 200a) is needed, and the electronic terminal can be directly placed on the bearing body 100.

It should be understood that the first clamping member 200a can be maintained at a certain position of the bearing body 100, which means that the first clamping member 200a is in a balanced state at that position. When the first clamping member 200a is required to leave the certain position, the user can apply force to the first clamping member 200a to make it leave that position. When the first clamping member 200a is required to return to the certain position, the user can apply force to the first clamping member 200a to make it return to that position.

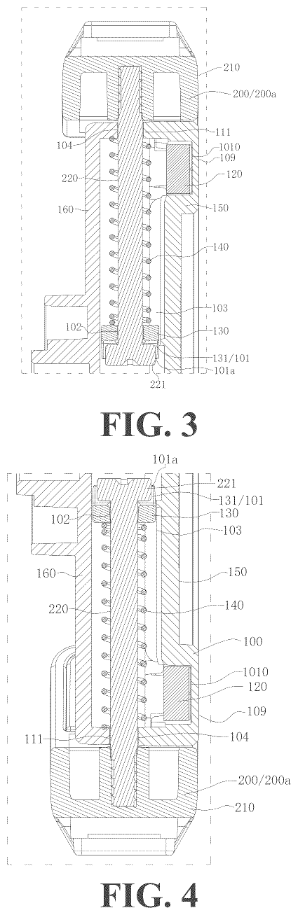

In some embodiments of the present disclosure, referring to FIGS. 3, 4, and 9-11, the bearing body 100 includes a first limiting portion 131 corresponding to each first clamping member 200a. The first clamping member 200a includes a second limiting portion 221 adapted to the first limiting portion 131. In the process of the first clamping member 200a moving from the first position to the second position relative to the bearing body 100, the second limiting portion 221 and the first limiting portion 131 change from a disengaged state to an engaged state. The second limiting portion 221 and the first limiting portion 131 being in the engaged state enables the first clamping member 200a to be maintained at the second position relative to the bearing body 100. In the process of the first clamping member 200a moving from the second position to the first position, the second limiting portion 221 and the first limiting portion 131 change from the engaged state to the disengaged state.

In the above embodiments, by having the second limiting portion 221 and the first limiting portion 131 in the engaged state, the first clamping member 200a can be maintained at the second position.

For example, during the process where the second limiting portion 221 and the first limiting portion 131 transition from the disengaged state to the engaged state or from the engaged state to the disengaged state, the second limiting portion 221 or the first limiting portion 131 undergoes elastic deformation to enable the second limiting portion 221 and the first limiting portion 131 to transition from the disengaged state to the engaged state or from the engaged state to the disengaged state.

For example, during the process where the second limiting portion 221 and the first limiting portion 131 transition from the disengaged state to the engaged state or from the engaged state to the disengaged state, the second limiting portion 221 slides relative to the first limiting portion 131 to enable the second limiting portion 221 and the first limiting portion 131 to transition from the disengaged state to the engaged state or from the engaged state to the disengaged state.

For example, the first limiting portion 131 is a groove, and the second limiting portion 221 is a protrusion; or, the first limiting portion 131 is a protrusion, and the second limiting portion 221 is a groove.

In other examples, both the first limiting portion 131 and the second limiting portion 221 are protrusions, the first limiting portion 131 and the second limiting portion 221 are in tight cooperation, or the first limiting portion 131 abuts against the second limiting portion 221 to maintain the first clamping member 200a at the second position.

It should be understood that the number of first limiting portions 131 is the same as the number of first clamping members 200a. For example, when there is one first clamping member 200a provided, there is one first limiting portion 131 provided; and when there are two first clamping members 200a provided, there are two first limiting portions 131 provided.

It can be understood that there are different ways for the first limiting portion 131 and the second limiting portion 221 to transition from the engaged state to the disengaged state. For example, the first clamping member 200a moves away from the bearing body 100 such that the first limiting portion 131 first moves away from the second limiting portion 221, and then the first clamping member 200a is rotated to bring the first limiting portion 131 and the second limiting portion 221 into the disengaged state. Alternatively, the first clamping member 200a is retractable relative to the bearing body 100, and by directly rotating the first clamping member 200a, the first limiting portion 131 and the second limiting portion 221 are brought into the disengaged state.

For example, the bearing body 100 includes a first main body 110. The first limiting portion 131 is fixedly arranged on the first main body 110, and the second limiting portion 221 is fixedly arranged on the first clamping member 200a. The first clamping member 200a is rotatably arranged on the first main body 110 about a first axis. The first clamping member 200a is axially fixed relative to the first main body 110. During a process where the first limiting portion 131 and the second limiting portion 221 transition from the disengaged state to the engaged state or from the engaged state to the disengaged state, the first limiting portion 131 undergoes elastic deformation (or the second limiting portion 221 undergoes elastic deformation) to enable the first limiting portion 131 and the second limiting portion 221 to transition from the disengaged state to the engaged state or from the engaged state to the disengaged state.

For example, the bearing body 100 includes a first main body 110. The first limiting portion 131 is fixedly arranged on the first main body 110, and the second limiting portion 221 is fixedly arranged on the first clamping member 200a. The first clamping member 200a is rotatably arranged on the first main body 110 about a first axis. The first clamping member 200a is elastically retractable along the axial direction relative to the first main body 110. During a process where the first limiting portion 131 and the second limiting portion 221 transition from the disengaged state to the engaged state or from the engaged state to the disengaged state, the first clamping member 200a is elastically retractable relative to the first main body 110 to enable the first limiting portion 131 and the second limiting portion 221 to transition from the disengaged state to the engaged state or from the engaged state to the disengaged state.

For example, the bearing body 100 includes a first main body 110. The first limiting portion 131 is movably arranged on the first main body 110, and the second limiting portion 221 is fixedly arranged on the first clamping member 200a. During a process where the first limiting portion 131 and the second limiting portion 221 transition from the disengaged state to the engaged state or from the engaged state to the disengaged state, the first limiting portion 131 moves relative to the first main body 110 to enable the first limiting portion 131 and the second limiting portion to transition from the disengaged state to the engaged state or from the engaged state to the disengaged state. For example, the first limiting portion 131 is slidably arranged on the first main body 110, or the first limiting portion 131 is rotatably arranged on the first main body 110.

It can be understood that when the first limiting portion 131 and the second limiting portion 221 transition from the disengaged state to the engaged state, the first clamping member 200a is maintained at the second position. When the user swings the bearing device 1 or moves the terminal holder, the first clamping member 200a remains at the second position. When the user adjusts the first clamping member 200a, in a case where the external force applied to the first clamping member 200a is greater than the holding force keeping it at the second position, the first limiting portion 131 and the second limiting portion 221 can be caused to transition from the engaged state to the disengaged state.

In some embodiments of the present disclosure, referring to FIGS. 3, 4, 9, 10, and 11, the bearing body 100 includes a first main body 110. The bearing body 100 further includes a first slidable member 130 and a first elastic element 140 corresponding to each first clamping member 200a. The first slidable member 130 is slidably arranged on the first main body 110. The first limiting portion 131 is arranged on the first slidable member 130. An end of the first elastic element 140 acts on the first main body 110, and the other end of the first elastic element 140 acts on the first slidable member 130. The first elastic element 140 can cause the first slidable member 130 to abut against the first clamping member 200a. When the first clamping member 200a is at the second position relative to the bearing body 100, the first elastic element 140 causes the first limiting portion 131 and the second limiting portion 221 to be in the engaged state. During the process where the first limiting portion 131 and the second limiting portion 221 transition from the engaged state to the disengaged state or from the disengaged state to the engaged state, the first elastic element 140 deforms, and the first slidable member 130 slides relative to the first main body 110 to facilitate the first limiting portion 131 and the second limiting portion 221 transitioning from the engaged state to the disengaged state or from the disengaged state to the engaged state.

In the above embodiments, the two ends of the first elastic element 140 act on the first main body 110 and the first slidable member 130 respectively, causing the first limiting portion 131 and the second limiting portion 221 to be in the engaged state, such that the first clamping member 200a is stably maintained at the second position, which enables the electronic terminal to be smoothly placed on the bearing body 100.

It can be understood that the first elastic element 140 enables the first slidable member 130 to be elastically retractable relative to the first main body 110, thereby facilitating the user to adjust the first clamping member 200a such that the first limiting portion 131 and the second limiting portion 221 transition from the engaged state to the disengaged state.

It should be understood that the number of first slidable members 130 and the number of first elastic elements 140 are each the same as the number of first clamping members 200a. For example, when there is one first clamping member 200a provided, there is one first slidable member 130 and one first elastic element 140 provided; and when there are two first clamping members 200a provided, there are two first slidable members 130 and two first elastic elements 140 provided.

It can be understood that when the first slidable member 130 abuts against the first clamping member 200a, the first limiting portion 131 and the second limiting portion 221 of the first clamping member 200a are in the engaged state, or the first limiting portion 131 corresponds to other portions of the first clamping member 200a, or the second limiting portion 221 corresponds to other portions of the first slidable member 130.

It can be understood that during the process where the first limiting portion 131 and the second limiting portion 221 transition from the engaged state to the disengaged state or from the disengaged state to the engaged state, the first slidable member 130 slides relative to the first clamping member 200a to facilitate the user's adjustment of the first clamping member 200a such that the first limiting portion 131 and the second limiting portion 221 transition from the engaged state to the disengaged state or from the disengaged state to the engaged state.

For example, the first magnetic member 120 is arranged on the first main body 110.

For example, the first elastic element 140 may be a spring, an elastic piece, an elastic rope, etc.

For example, the first clamping member 200a is rotatably arranged on the first main body 110 such that the first clamping member 200a is rotatably arranged on the bearing body 100.

For example, the first clamping member 200a is rotatably arranged on the first slidable member 130 such that the first clamping member 200a is rotatably arranged on the bearing body 100.

For example, the first clamping member 200a is rotatably arranged on the bearing body 100. The first clamping member 200a is axially fixed relative to the bearing body 100. During a process where the first clamping member 200a rotates relative to the bearing body 100, the first limiting portion 131 and the second limiting portion 221 transition from the disengaged state to the engaged state or from the engaged state to the disengaged state. Moreover, during the process where the first limiting portion 131 and the second limiting portion 221 transition from the engaged state to the disengaged state or from the disengaged state to the engaged state, the first slidable member 130 slides relative to the rotating connection portion 220 to facilitate the first limiting portion 131 and the second limiting portion 221 transitioning from the engaged state to the disengaged state or from the disengaged state to the engaged state. In the embodiments, the sliding direction of the first slidable member 130 may be parallel to the first axis, or the sliding direction of the first slidable member 130 forms an angle with the first axis.

For example, during the process where the first limiting portion 131 and the second limiting portion 221 transition from the engaged state to the disengaged state or from the disengaged state to the engaged state, the rotating connection portion 220 is axially stationary relative to the first main body 110, the first elastic element 140 deforms, and the first slidable member 130 slides relative to the first main body 110 to facilitate the first limiting portion 131 and the second limiting portion 221 transitioning from the engaged state to the disengaged state or from the disengaged state to the engaged state.

For example, during the process where the first limiting portion 131 and the second limiting portion 221 transition from the engaged state to the disengaged state or from the disengaged state to the engaged state, the first slidable member 130 is axially stationary relative to the first main body 110, and the rotating connection portion 220 slides relative to the first main body 110 to facilitate the first limiting portion 131 and the second limiting portion 221 transitioning from the engaged state to the disengaged state or from the disengaged state to the engaged state.

For example, the first clamping member 200a is rotatably arranged on the bearing body 100. The first clamping member 200a is elastically retractable along the axial direction relative to the bearing body 100. During the process of rotating the first clamping member 200a, the first limiting portion 131 and the second limiting portion 221 transition from the disengaged state to the engaged state or from the engaged state to the disengaged state. Moreover, during the process where the first limiting portion 131 and the second limiting portion 221 transition from the engaged state to the disengaged state or from the disengaged state to the engaged state, the first clamping member 200a is retractable relative to the bearing body 100, and the first slidable member 130 slides relative to the first main body 110 to facilitate the first limiting portion 131 and the second limiting portion 221 transitioning from the engaged state to the disengaged state or from the disengaged state to the engaged state. For example, the bearing device 1 further includes a fourth elastic element. The first clamping member 200a is slidably arranged on the bearing body 100. The fourth elastic element acts on the first clamping member 200a and the bearing body 100 to enable the first clamping member 200a to be elastically retractable relative to the bearing body 100. In the embodiments, the sliding direction of the first slidable member 130 may be parallel to the sliding direction of the first clamping member 200a, or the sliding direction of the first slidable member 130 forms an angle with the sliding direction of the first clamping member 200a.

In some embodiments of the present disclosure, referring to FIGS. 3, 4, 9, 10, and 11, the first limiting portion 131 is a first groove 101, and the second limiting portion 221 is a first protrusion 221; or, the first limiting portion 131 is a first protrusion 221, and the second limiting portion 221 is a first groove 101. The first protrusion 221 is engaged in the first groove 101 to realize that the first limiting portion 131 and the second limiting portion 221 are in the engaged state. The advantage of this arrangement is that by setting the first limiting portion 131 and the second limiting portion 221 as the first protrusion 221 and the first groove 101, on the one hand, the first clamping member 200a may quickly locate the second position during the adjustment process; on the other hand, the first protrusion 221 being engaged in the first groove 101 enables the first clamping member 200a to be stably maintained at the second position.

It can be understood that the first protrusion 221 is adapted to the first groove 101.

In some embodiments of the present disclosure, referring to FIGS. 3, 4, 9, 10, and 11, the first groove 101 is in an open shape. The advantage of this arrangement is that when the first clamping member 200a rotates relative to the bearing body 100, it is beneficial for the first protrusion 221 and the first groove 101 to transition from the engaged state to the disengaged state. Moreover, since the first groove 101 is in an open shape, during the process where the first limiting portion 131 and the second limiting portion 221 transition from the disengaged state to the engaged state or from the engaged state to the disengaged state, the first protrusion 221 is not easy to damage the first groove 101.

It can be understood that the shape of the first protrusion 221 is adapted to the first groove 101.

For example, the first groove 101 extends along a straight line, and the first protrusion 221 extends along a straight line. When the first limiting portion 131 and the second limiting portion 221 are in the engaged state, the extending direction of the first protrusion 221 is the same as the extending direction of the first groove 101.

For example, the first groove 101 extends along a curve, and the first protrusion 221 extends along a curve. When the first limiting portion 131 and the second limiting portion 221 are in the engaged state, the extending trajectory of the first protrusion 221 is the same as the extending trajectory of the first groove 101. For example, the extending trajectory of the first groove 101 is S-shaped.

It can be understood that the first groove 101 being in an open shape means that the first groove 101 has a first opening 101a. The cross-section of the first groove 101 increases from the bottom wall of the first groove 101 to the first opening 101a.

In some embodiments, the cross-section of the first groove 101 gradually increases from a bottom wall of the first groove 101 to the first opening 101a. For example, the first groove 101 may be semicircular or V-shaped.

In some other examples, the cross-section of the first groove 101 remains unchanged from the bottom wall of the first groove 101 to the first opening 101a. For example, the first groove 101 is U-shaped.

In some embodiments of the present disclosure, referring to FIG. 10, the first groove 101 extends in a direction parallel to a first straight line. The cross-section of the first groove 101 is V-shaped, and the first protrusion 221 is cylindrical. When the first limiting portion 131 and the second limiting portion 221 are in the engaged state, the axis of the first protrusion 221 is parallel to the first straight line. On the one hand, the first groove 101 is V-shaped and the first protrusion 221 is cylindrical, such that when the first protrusion 221 and the first groove 101 transition from the engaged state to the disengaged state, the first protrusion 221 is not easy to damage the first groove 101. On the other hand, the tolerance of the diameter size of the first protrusion 221 does not affect the first protrusion 221 and the first groove 101 being in the engaged state.

It can be understood that the cross-section of the first groove 101 is perpendicular to the first straight line.

In other examples, the first groove 101 extends in a direction parallel to the first straight line. The cross-section of the first groove 101 perpendicular to the first straight line is semicircular, U-shaped, etc.

In other examples, the first protrusion 221 is columnar, such as a square column or a polygonal column.

In some embodiments of the present disclosure, referring to FIGS. 3, 4, 9, 10, and 11, the first clamping member 200a is rotatably arranged on the bearing body 100 about a first axis. The first slidable member 130 is slidably arranged on the first main body 110 in a direction parallel to the first axis. The first slidable member 130 is peripherally fixed relative to the first main body 110 about the first axis. The first clamping member 200a is slidably arranged on the bearing body 100 in a direction parallel to the first axis. During the process where the first clamping member 200a slides relative to the bearing body 100, the first slidable member 130 always abuts against the first clamping member 200a. The first elastic element 140 acts on the first slidable member 130. The first slidable member 130 abuts against the first clamping member 200a. The first clamping member 200a is slidably arranged on the bearing body 100 in a direction parallel to the first axis, such that the first clamping member 200a is elastically retractable relative to the bearing body 100. When the first clamping member 200a extends or retracts relative to the bearing body 100, the clamping width of the bearing device 1 can be changed. The first elastic element 140 enables the bearing device 1 to have a clamping force for clamping the electronic terminal. When the first clamping member 200a is at the second position, the first clamping member 200a is retracted into the bearing body 100.

In some embodiments, the first elastic element 140 causes the first slidable member 130 to abut against the first clamping member 200a. When the bearing device 1 is not clamping the electronic terminal, the first elastic element 140 causes the first slidable member 130 to abut against the first clamping member 200a such that the first clamping member 200a is retracted into the bearing body 100. When the first clamping member 200a extends relative to the bearing body 100, the first elastic element 140 causes the first slidable member 130 to abut against the first clamping member 200a such that the first clamping member 200a has a clamping force for clamping the electronic terminal. The first elastic element 140 and the first slidable member 130 enable the first clamping member 200a to be elastically retractable in a direction parallel to the first axis. When the first clamping member 200a extends or retracts relative to the bearing body 100, the clamping width of the bearing device 1 can be changed.

It can be understood that the first elastic element 140 does not directly act on the first clamping member 200a, avoiding the rotation of the first clamping member 200a from affecting the first elastic element 140, such as the rotation of the first clamping member 200a causing unfavorable winding of the first elastic element 140.

It can be understood that on the one hand, the first elastic element 140 acts on the first slidable member 130 to facilitate the first limiting portion 131 and the second limiting portion 221 transitioning from the engaged state to the disengaged state or from the disengaged state to the engaged state; on the other hand, the first elastic element 140 acts on the first clamping member 200a through the first slidable member 130 to provide a clamping force for clamping the electronic terminal for the first clamping member 200a, making the overall structure of the bearing device 1 compact and occupy small volume.

It can be understood that the first slidable member 130 being peripherally fixed relative to the first main body 110 about the first axis means that the first slidable member 130 cannot rotate relative to the first main body 110 about the first axis. The advantage of this arrangement is that it avoids a situation where when the first limiting portion 131 and the second limiting portion 221 transition from the engaged state to the disengaged state, the first slidable member 130 rotates relative to the first main body 110 about the first axis, which could cause the first limiting portion 131 and the second limiting portion 221 to be unable to transition from the engaged state to the disengaged state.

It can be understood that the sliding direction of the first slidable member 130 and the sliding direction of the first clamping member 200a are both parallel to the first axis, which facilitates the realization that during the process where the first clamping member 200a slides relative to the bearing body 100, the first limiting portion 131 always abuts against the first clamping member 200a.

It can be understood that the first clamping member 200a is both rotatable about the first axis and elastically retractable along the first axis, making the structure of the bearing device 1 very compact.

It can be understood that during the process where the first clamping member 200a slides relative to the bearing body 100, the first limiting portion 131 always abuts against the first clamping member 200a, such that during the process where the first clamping member 200a extends or retracts relative to the bearing body 100, the first clamping member 200a can always be subjected to the elastic force from the first elastic element 140, thereby enabling the bearing device 1 to clamp electronic terminals of different widths.

It can be understood that the first elastic element 140 provides the clamping force for clamping the electronic terminal for the two clamping members 200.

For example, the first slidable member 130 is slidably arranged in a first sliding groove 103 of the first main body 110. The cross-section of the first slidable member 130 is adapted to the cross-section of the first sliding groove 103. The cross-section of the first slidable member 130 is non-circular, such that the first slidable member 130 is peripherally fixed relative to the first sliding groove 103 about the first axis. For example, the cross-section of the first slidable member 130 is semicircular, elliptical, polygonal, track-shaped, etc. The first slidable member 130 being peripherally fixed relative to the first sliding groove 103, on the one hand, makes the sliding of the first slidable member 130 relative to the first sliding groove 103 more stable; on the other hand, when the first clamping member 200a rotates relative to the first slidable member 130, it is more stable.

It can be understood that the first clamping member 200a is elastically retractable relative to the bearing body 100. On the one hand, it facilitates the adjustment of the first clamping member 200a during the process where the bearing device 1 clamps the electronic terminal, such that the electronic terminal is clamped by the two clamping members 200; on the other hand, it facilitates the adjustment of the clamping width of the bearing device 1 to clamp electronic terminals of different widths.

It can be understood that when the first clamping member 200a is at the second position, the bearing device 1 is not clamping the electronic terminal, and the first clamping member 200a is retracted into the bearing body 100 under the action of the first elastic element 140.

In other embodiments, the sliding direction of the first slidable member 130 is not parallel to the first axis. The bearing device 1 includes a fourth elastic element. The fourth elastic element acts on the first clamping member 200a and the bearing body 100. The fourth elastic element enables the first clamping member 200a to be elastically retractable relative to the bearing body 100.

For example, the first limiting portion 131 is a first protrusion 221. During the process where the first clamping member 200a slides relative to the bearing body 100, the first limiting portion 131 of the first slidable member 130 always abuts against the first clamping member 200a.

For example, the second limiting portion 221 is a first protrusion 221. During the process where the first clamping member 200a slides relative to the bearing body 100, the first slidable member 130 always abuts against the second limiting portion 221.

For example, the first clamping member 200a is directly rotatably arranged on the first main body 110 about the first axis, which may realize that the first clamping member 200a is rotatably arranged on the bearing body 100 about the first axis.

For example, the first clamping member 200a is directly slidably arranged on the first main body 110 in a direction parallel to the first axis, which may realize that the first clamping member 200a is slidably arranged on the bearing body 100 in a direction parallel to the first axis.

In other embodiments, the first clamping member 200a is axially fixed relative to the bearing body 100.

In some embodiments of the present disclosure, referring to FIGS. 3, 4, 9, 10, and 11, the first clamping member 200a is rotatably arranged on the first slidable member 130 about a first axis such that the first clamping member 200a is rotatably arranged on the bearing body 100 about the first axis. During the process where the first limiting portion 131 and the second limiting portion 221 transition from the engaged state to the disengaged state or from the disengaged state to the engaged state, the first slidable member 130 slides relative to the first clamping member 200a in a direction parallel to the first axis. During the process where the first clamping member 200a is extends/retracts relative to the bearing body 100, the first slidable member 130 always follows the first clamping member 200a such that the first clamping member 200a slides relative to the bearing body 100 in a direction parallel to the first axis. During the process where the first clamping member 200a slides relative to the bearing body 100 in the direction parallel to the first axis, the first slidable member 130 always abuts against the first clamping member 200a, thereby preventing the first clamping member 200a from disengaging from the first slidable member 130.

It can be understood that the first slidable member 130 not only enables the first clamping member 200a to rotate about the first axis relative to the bearing body 100 but also enables the first clamping member 200a to slide along the direction of the first axis relative to the bearing body 100, thereby making the bearing device 1 structurally compact.

It can be understood that the first clamping member 200a is rotatable about the first axis relative to the first slidable member 130. Because the first slidable member 130 is peripherally fixed about the first axis relative to the bearing body 100, the first clamping member 200a can be rotatably arranged on the bearing body 100 about the first axis.

For example, the first clamping member 200a is sleeved on the first slidable member 130, or the first slidable member 130 is sleeved on the first clamping member 200a.

It can be understood that during the process where the first clamping member 200a slides relative to the bearing body 100 in the direction parallel to the first axis, the first clamping member 200a does not disengage from the first slidable member 130, thereby ensuring that the first clamping member 200a always slides relative to the bearing body 100 in the direction parallel to the first axis.

In other examples, the first clamping member 200a is directly rotatably arranged on the first main body 110 about the first axis, and the first clamping member 200a is directly slidably arranged on the first main body 110 in a direction parallel to the first axis, thereby enabling the first clamping member 200a to slide relative to the bearing body 100 in the direction parallel to the first axis.

It can be understood that during the process where the first limiting portion 131 and the second limiting portion 221 transition from the engaged state to the disengaged state or from the disengaged state to the engaged state, the first slidable member 130 slides relative to the first clamping member 200a, thereby facilitating the user's adjustment of the first clamping member 200a to transition the first limiting portion 131 and the second limiting portion 221 from the engaged state to the disengaged state or from the disengaged state to the engaged state.

It can be understood that the first clamping member 200a is rotatably arranged on the first slidable member 130 about the first axis, and the first slidable member 130 can slide relative to the first slidable member 130 in a direction parallel to the first axis. One implementation is that the first clamping member 200a and the first slidable member 130 may be connected by a cylindrical pair, for example, the first clamping member 200a is sleeved on the first slidable member 130, or the first slidable member 130 is sleeved on the first clamping member 200a.

For example, the second limiting portion 221 is a first protrusion 221. When the first clamping member 200a extends relative to the bearing body 100, the first protrusion 221 abuts against the first slidable member 130, and the first protrusion 221 drives the first slidable member 130 to slide. When the first clamping member 200a retracts relative to the bearing body 100, the first elastic element 140 pushes the first slidable member 130 to slide, and the first slidable member 130 abuts against the first protrusion 221.

For example, the second limiting portion 221 is a first groove, and the first limiting portion 131 is a first protrusion, where the first groove is defined on a first protruding portion, and the first protruding portion protrudes from the first clamping member 200a. When the first clamping member 200a extends relative to the bearing body 100, the first protruding portion abuts against the first slidable member 130, and the first protruding portion drives the first slidable member 130 to slide. When the first clamping member 200a retracts relative to the bearing body 100, the first elastic element 140 pushes the first slidable member 130 to slide, and the first slidable member 130 abuts against the first protruding portion.

In some embodiments of the present disclosure, referring to FIGS. 3, 4, 9, 10, and 11, the first clamping member 200a includes a first clamping portion 210 and a rotating connection portion 220. The first clamping portion 210 is configured to clamp the electronic terminal. The first clamping portion 210 is arranged on the rotating connection portion 220. The first slidable member 130 defines a first connection hole 102. The rotating connection portion 220 is sleeved into the first connection hole 102. The rotating connection portion 220 rotates relative to the first connection hole 102 about the first axis, enabling the first clamping member 200a to be rotatably connected to the bearing body 100 about the first axis. During the process where the first limiting portion 131 and the second limiting portion 221 transition from the engaged state to the disengaged state or from the disengaged state to the engaged state, the first connection hole 102 slides relative to the rotating connection portion 220 in a direction parallel to the first axis. During the process where the first clamping member 200a slides relative to the bearing body 100 in the direction parallel to the first axis, the first slidable member 130 always follows the rotating connection portion 220.

It can be understood that the rotating connection portion 220 is rotatably arranged on the first slidable member 130 about the first axis, enabling the first clamping member 200a to be rotatably arranged on the bearing body 100 about the first axis.

It can be understood that the rotating connection portion 220 is slidable relative to the bearing body 100 in a direction parallel to the first axis, enabling the first clamping member 200a to slide relative to the bearing body 100 in the direction parallel to the first axis.

It can be understood that the rotating connection portion 220 is rotatably connected to the first connection hole 102 of the first slidable member 130 about the first axis. The first connection hole 102 is slidable relative to the rotating connection portion 220 in the direction of the first axis. The cooperation between the rotating connection portion 220 and the first connection hole 102 is a cylindrical pair. The first connection hole 102 may be a cylindrical hole, and a part of the rotating connection portion 220 cooperating with the first connection hole 102 may be cylindrical.

It can be understood that the structure of the rotating connection portion 220 and the first slidable member 130 not only enables the first clamping member 200a to be retractable relative to the bearing body 100 but also enables the first clamping member 200a to rotate relative to the bearing body 100, and can further keep the first clamping member 200a at the second position, thereby making the structure of the bearing device 1 compact.

For example, the first clamping portion 210 is sheet-shaped, strip-shaped, etc.

For example, the first clamping portion 210 is arranged with an anti-slip soft pad.

For example, the second limiting portion 221 and the first clamping portion 210 are disposed on two ends of the rotating connection portion 220, respectively.

For example, the first clamping portion 210 is fixedly arranged on the rotating connection portion 220. For example, the rotating connection portion 220 and the first clamping portion 210 are threadedly connected.

In other embodiments, the rotating connection portion 220 defines a first sliding hole, and the first slidable member 130 is arranged with a first guide rod. The first guide rod is slidably arranged in the first sliding hole in a direction parallel to the first axis and is rotatably arranged in the first sliding hole about the first axis, enabling the rotating connection portion 220 to be rotatably arranged on the first slidable member 130 and the first slidable member 130 to be slidable relative to the first guide rod.

In some embodiments of the present disclosure, referring to FIGS. 3, 4, 9, 10, and 11, the first limiting portion 131 is a first groove 101, the second limiting portion 221 is a first protrusion 221, and the first protrusion 221 is engaged in the first groove 101 to achieve the engaged state between the first limiting portion 131 and the second limiting portion 221. The first protrusion 221 protrudes from the rotating connection portion 220. When the first clamping member 200a extends relative to the bearing body 100, the first protrusion 221 pushes the first slidable member 130 to cause the first slidable member 130 to slide relative to the first main body 110. When the first clamping member 200a retracts relative to the bearing body 100, the first elastic element 140 pushes the first slidable member 130 to cause the first slidable member 130 to slide relative to the first main body 110.

It can be understood that the first protrusion 221 and the first elastic element 140 ensure that during the process where the first clamping member 200a extends or retracts relative to the bearing body 100, the first slidable member 130 always follows the rotating connection portion 220 and never disengages from it, thereby enabling the first slidable member 130 to achieve a sliding connection between the rotating connection portion 220 and the bearing body 100.

It can be understood that the first protrusion 221 not only can limit the position of the first clamping member 200a but also, together with the first elastic element 140 and the first slidable member 130, enables the first clamping member 200a to be elastically retractable relative to the bearing body 100, thereby making the structure of the bearing device 1 more compact.

It can be understood that rotating the first clamping member 200a can cause the first protrusion 221 and the first groove 101 to transition from the disengaged state to the engaged state or from the engaged state to the disengaged state. When the first clamping member 200a is rotated to the second position relative to the bearing body 100, the first clamping portion 210 is stacked on the bearing body 100, and the first protrusion 221 and the first groove 101 are in the engaged state to keep the first clamping member 200a at the second position relative to the bearing body 100. The first slidable member 130 is peripherally fixed about the first axis relative to the first main body 110. During the process where the first protrusion 221 and the first groove 101 transition from the disengaged state to the engaged state or from the engaged state to the disengaged state, the first slidable member 130 slides relative to the rotating connection portion 220.

In some embodiments of the present disclosure, referring to FIGS. 3, 4, and 9, the first elastic element 140 is a first spring 140, and the first spring 140 surrounds the rotating connection portion 220. The first spring 140 is helical. The first main body 110 defines a first sliding groove 103 corresponding to each first clamping member 200a. The first slidable member 130 is slidably arranged in the first sliding groove 103. The first spring 140 is accommodated in the first sliding groove 103.

It can be understood that the first spring 140 surrounds the rotating connection portion 220 and is accommodated in the first sliding groove 103, making the structure of the bearing device 1 compact and occupy small volume.

It can be understood that at least part of the rotating connection portion 220 is disposed within the first sliding groove 103.

For example, the first spring 140 may be a cylindrical helical spring, or the first spring 140 may be a conical helical spring.

It should be understood that the number of first sliding grooves 103 is the same as the number of first clamping members 200a.

In other embodiments, the first spring 140 is not accommodated in the first sliding groove 103.

In other embodiments, the first slidable member 130 defines a second sliding hole, and the first main body 110 is arranged with a second guide rod. The second guide rod is slidably arranged on the second guide rod in the direction of the first axis to enable the first slidable member 130 to be slidably arranged on the first main body 110.

For example, the first spring 140 may be a tension spring. The first slidable member 130 is disposed between the first spring 140 and the first clamping portion 210. When the first clamping member 200a extends relative to the bearing body 100, the clamping width of the bearing device 1 increases, and the first spring 140 stretches.

For example, the first spring 140 may be a compression spring. The first spring 140 is disposed between the first clamping portion 210 and the first slidable member 130. When the first clamping member 200a extends relative to the bearing body 100, the clamping width of the bearing device 1 increases, and the first spring 140 compresses.

It can be understood that the first spring 140 provides the clamping force for the bearing device 1 to clamp the electronic terminal. The first spring 140 may provide the entire clamping force or only part of the clamping force.

For example, the first spring 140 is a cylindrical helical spring. The width of the first sliding groove 103 matches the first spring 140. The first spring 140 is coaxial with the first axis.

For example, the width of the first sliding groove 103 is greater than the outer diameter of the first spring 140.

In other embodiments, the first elastic element 140 is an elastic sheet, an elastic rope, etc.

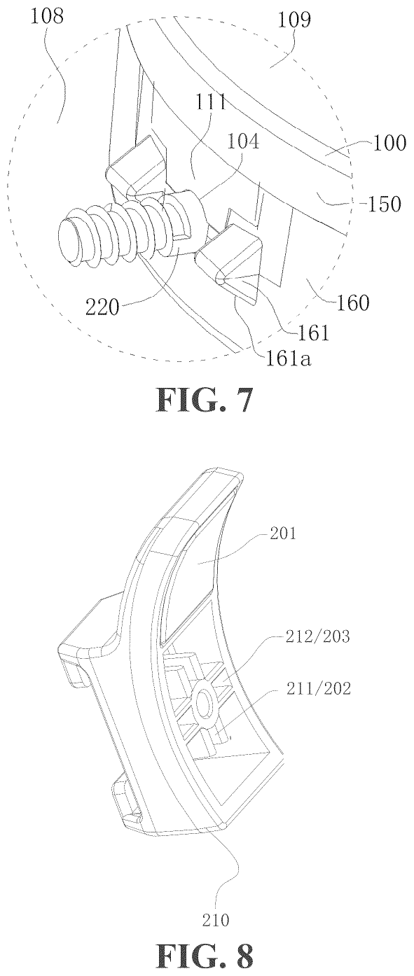

In some embodiments of the present disclosure, referring to FIG. 7, the first main body 110 defines a second connection hole 104 corresponding to each first clamping member 200a. The second connection hole 104 is coaxial with the first connection hole 102. The rotating connection portion 220 is slidably arranged in the second connection hole 104 in a direction parallel to the first axis, and the rotating connection portion 220 is rotatably arranged in the second connection hole 104 about the first axis.

It can be understood that the rotating connection portion 220 is both rotatably arranged in the first connection hole 102 and rotatably arranged in the second connection hole 104, making the rotation of the rotating connection portion 220 relative to the bearing body 100 more stable.

It can be understood that the rotating connection portion 220 is both slidably arranged in the first connection hole 102 and slidably arranged in the second connection hole 104, making the sliding of the rotating connection portion 220 relative to the bearing body 100 more stable.

It should be understood that the number of second connection holes 104 is the same as the number of first clamping members 200a.

In some embodiments of the present disclosure, referring to FIGS. 3, 4, and 7, the first main body 110 has a first wall body 111 corresponding to each first clamping member 200a. The first wall body 111 is spaced apart from the first slidable member 130. The first elastic element 140 is disposed between the first wall body 111 and the first slidable member 130. An end of the first elastic element 140 acts on the first wall body 111, and the other end of the first elastic element 140 acts on the first slidable member 130. The second connection hole 104 is defined on the first wall body 111.

It can be understood that the first wall body 111 and the first slidable member 130 are spaced apart, creating an interval between the first connection hole 102 and the second connection hole 104, further making the rotation or sliding of the rotating connection portion 220 relative to the bearing body 100 more stable.

It can be understood that the first elastic element 140 is disposed between the first wall body 111 and the first slidable member 130, making the structure of the bearing device 1 more compact and occupy smaller volume.

It should be understood that the number of first wall bodies 111 is the same as the number of first clamping members 200a.

In some embodiments of the present disclosure, referring to FIGS. 3, 4, and 7, the first elastic element 140 is a first spring 140. The first spring 140 is helical and surrounds the rotating connection portion 220. The first main body 110 defines a first sliding groove 103 corresponding to each first clamping member 200a. The first slidable member 130 is slidably arranged in the first sliding groove 103. The first spring 140 is accommodated in the first sliding groove 103. The first spring 140 is a compression spring. When the first clamping member 200a extends relative to the bearing body 100, the first slidable member 130 moves closer to the first wall body 111.

It can be understood that the first wall body 111 and the first slidable member 130 are spaced apart, which on the one hand facilitates the installation of the first elastic element 140, and on the other hand provides a moving space for the first slidable member 130 to slide towards the first wall body 111.

It can be understood that setting the first spring 140 as a compression spring makes its structure more compact than a tension spring of the same length, which may make the structure of the bearing device 1 more compact.

For example, the first wall body 111 is disposed on an outer shell of the first main body 110.

It can be understood that when the first clamping member 200a extends relative to the bearing body 100, the clamping width of the bearing device 1 increases.

In other embodiments, the first spring 140 may be a tension spring. The first slidable member 130 is disposed between the first spring 140 and the first clamping portion 210. When the first clamping member 200a extends relative to the bearing body 100, the first slidable member 130 moves away from the first wall body 111. The first wall body 111 may be disposed on an inner wall of the first main body 110.

In some embodiments of the present disclosure, referring to FIGS. 3, 4, and 7, the first slidable member 130 defines a first connection hole 102. The first main body 110 has a first wall body 111 corresponding to each first limiting portion 131. The first wall body 111 defines a second connection hole 104. The first connection hole 102 and the second connection hole 104 are coaxial. The first wall body 111 and the first slidable member 130 are spaced apart. The first clamping member 200a is rotatably arranged in the first connection hole 102 about the first axis. During the process where the first limiting portion 131 and the second limiting portion 221 transition from the engaged state to the disengaged state or from the disengaged state to the engaged state, the first connection hole 102 can slide relative to the first clamping member 200a in a direction parallel to the first axis. The first clamping member 200a is rotatably arranged in the second connection hole 104 about the first axis, and the first clamping member 200a can slide relative to the second connection hole 104 in a direction parallel to the first axis.

It can be understood that the first clamping member 200a is both rotatably arranged in the first connection hole 102 and rotatably arranged in the second connection hole 104, making the rotation of the first clamping member 200a relative to the bearing body 100 more stable.

It can be understood that the first clamping member 200a is both slidably arranged in the first connection hole 102 and slidably arranged in the second connection hole 104, making the sliding of the first clamping member 200a relative to the bearing body 100 more stable.

In other embodiments, the first clamping member 200a may be rotatably arranged on the bearing body 100 about the first axis and slidably arranged on the bearing body 100 along the first axis solely through cooperation with the second connection hole 104.

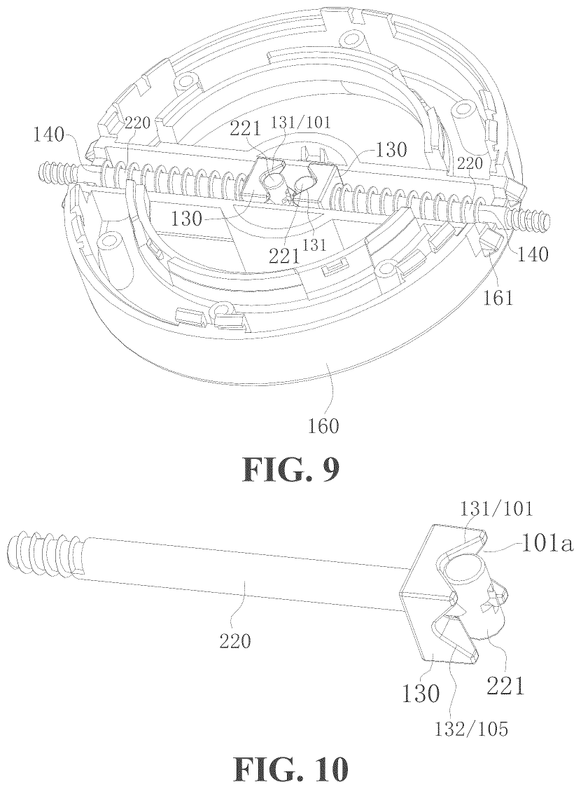

In some embodiments of the present disclosure, referring to FIGS. 9, 10, and 11, the bearing body 100 includes a third limiting portion 132 corresponding to each first clamping member 200a. The second limiting portion 221 is adapted to the third limiting portion 132. The first clamping member 200a is rotatably arranged on the bearing body 100 about the first axis. The first clamping member 200a is elastically retractable relative to the bearing body 100 in a direction parallel to the first axis. The elastic retractable of the first clamping member 200a relative to the bearing body 100 can change the clamping width of the bearing device 1. The first clamping member 200a can be rotated from the second position to a first ready-to-clamp position relative to the bearing body 100. The first clamping member 200a can be extended from the first ready-to-clamp position to the first position. When the first clamping member 200a is at the first ready-to-clamp position relative to the bearing body 100, the first clamping member 200a is retracted into the bearing body 100. During a process where the first clamping member 200a is rotated from the second position to the first ready-to-clamp position, the second limiting portion 221 and the third limiting portion 132 transition from a disengaged state to an engaged state. The engaged state of the second limiting portion 221 and the third limiting portion 132 enables the first clamping member 200a to be maintained at the first ready-to-clamp position relative to the bearing body 100. During a process where the first clamping member 200a is rotated from the first ready-to-clamp position to the second position, the third limiting portion 132 and the second limiting portion 221 transition from the engaged state to the disengaged state.

It can be understood that the engaged state of the third limiting portion 132 and the second limiting portion 221 can keep the first clamping member 200a at the first ready-to-clamp position, thereby preventing the first clamping member 200a from shaking at the first ready-to-clamp position and preventing it from returning to the second position from the first ready-to-clamp position. When the first clamping member 200a is required to clamp the electronic terminal, it is convenient to adjust the first clamping member 200a from the first ready-to-clamp position to the first position. For example, when the first clamping member 200a is kept at the first ready-to-clamp position, the electronic terminal may be operated to push the first clamping member 200a, moving the first clamping member 200a to the first position.

It can be understood that the engaged state of the third limiting portion 132 and the second limiting portion 221 can keep the first clamping member 200a at the first ready-to-clamp position, facilitating the user's adjustment of the first clamping member 200a from the first ready-to-clamp position to the first position.

It can be understood that when the first clamping member 200a is at the first ready-to-clamp position, the first clamping member 200a protrudes from the bearing surface 109.

For example, during the process where the second limiting portion 221 and the third limiting portion 132 transition from the disengaged state to the engaged state or from the engaged state to the disengaged state, the second limiting portion 221 or the third limiting portion 132 undergoes elastic deformation to enable the second limiting portion 221 and the third limiting portion 132 to transition from the disengaged state to the engaged state or from the engaged state to the disengaged state.

For example, during the process where the second limiting portion 221 and the third limiting portion 132 transition from the disengaged state to the engaged state or from the engaged state to the disengaged state, the second limiting portion 221 slides relative to the third limiting portion 132 to enable the second limiting portion 221 and the third limiting portion 132 to transition from the disengaged state to the engaged state or from the engaged state to the disengaged state.

For example, the third limiting portion 132 is a protrusion, and the second limiting portion 221 is a groove; or, the third limiting portion 132 is a groove, and the second limiting portion 221 is a protrusion.

For example, the first ready-to-clamp position may refer to one or more position points or a position range.

In other examples, both the third limiting portion 132 and the second limiting portion 221 are protrusions. The second limiting portion 221 and the third limiting portion 132 are in tight cooperation, or the second limiting portion 221 abuts against the third limiting portion 132, to keep the first clamping member 200a at the first ready-to-clamp position.

It should be understood that the number of third limiting portions 132 is the same as the number of first clamping members 200a.

In some embodiments of the present disclosure, referring to FIGS. 3, 4, 9, 10, and 11, the bearing body 100 includes a first main body 110. The bearing body 100 further includes a first slidable member 130 and a first elastic element 140 corresponding to each first clamping member 200a. The first slidable member 130 is slidably arranged on the first main body 110. The first limiting portion 131 is arranged on the first slidable member 130. The third limiting portion 132 is arranged on the first slidable member 130. An end of the first elastic element 140 acts on the first main body 110, and the other end of the first elastic element 140 acts on the first slidable member 130. The first elastic element 140 causes the first slidable member 130 to abut against the first clamping member 200a. When the first clamping member 200a is at the second position relative to the bearing body 100, the first elastic element 140 causes the first limiting portion 131 and the second limiting portion 221 to be in an engaged state. When the first clamping member 200a is at the first ready-to-clamp position relative to the bearing body 100, the first elastic element 140 causes the third limiting portion 132 and the second limiting portion 221 to be in an engaged state. During the process where the first limiting portion 131 and the second limiting portion 221 transition from the engaged state to the disengaged state or from the disengaged state to the engaged state, the first slidable member 130 slides relative to the first clamping member 200a to facilitate the first limiting portion 131 and the second limiting portion 221 transitioning from the engaged state to the disengaged state or from the disengaged state to the engaged state. During the process where the third limiting portion 132 and the second limiting portion 221 transition from the engaged state to the disengaged state or from the disengaged state to the engaged state, the first slidable member 130 slides relative to the first clamping member 200a to facilitate the third limiting portion 132 and the second limiting portion 221 transitioning from the engaged state to the disengaged state or from the disengaged state to the engaged state.

It can be understood that when the first slidable member 130 abuts against the first clamping member 200a, the first limiting portion 131 and the second limiting portion 221 are in the engaged state, or the second limiting portion 221 and the third limiting portion 132 are in the engaged state, or the second limiting portion 221 corresponds to other parts of the first slidable member 130.

For example, during the process where the first limiting portion 131 and the second limiting portion 221 transition from the engaged state to the disengaged state or from the disengaged state to the engaged state, the rotating connection portion 220 is axially stationary relative to the first main body 110, the first elastic element 140 deforms, and the first slidable member 130 slides relative to the first main body 110 to facilitate the first limiting portion 131 and the second limiting portion 221 transitioning from the engaged state to the disengaged state or from the disengaged state to the engaged state.

For example, during the process where the first limiting portion 131 and the second limiting portion 221 transition from the engaged state to the disengaged state or from the disengaged state to the engaged state, the first slidable member 130 is axially stationary relative to the first main body 110, and the rotating connection portion 220 slides relative to the first main body 110 to facilitate the first limiting portion 131 and the second limiting portion 221 transitioning from the engaged state to a disengaged state or from the disengaged state to the engaged state.

For example, during the process where the third limiting portion 132 and the second limiting portion 221 transition from the engaged state to the disengaged state or from the disengaged state to the engaged state, the rotating connection portion 220 is axially stationary relative to the first main body 110, the first elastic element 140 deforms, and the first slidable member 130 slides relative to the first main body 110 to facilitate the third limiting portion 132 and the second limiting portion 221 transitioning from the engaged state to the disengaged state or from the disengaged state to the engaged state.

For example, during the process where the third limiting portion 132 and the second limiting portion 221 transition from the engaged state to the disengaged state or from the disengaged state to the engaged state, the first slidable member 130 is axially stationary relative to the first main body 110, and the rotating connection portion 220 slides relative to the first main body 110 to facilitate the third limiting portion 132 and the second limiting portion 221 transitioning from the engaged state to the disengaged state or from the disengaged state to the engaged state.

In some embodiments of the present disclosure, referring to FIGS. 3, 4, 9, 10, and 11, the first limiting portion 131 is a first groove 101, the third limiting portion 132 is a second groove 105, and the second limiting portion 221 is a first protrusion 221. The first protrusion 221 is engaged in the first groove 101 to achieve the engaged state between the second limiting portion 221 and the first limiting portion 131. The first protrusion 221 is engaged in the second groove 105 to achieve the engaged state between the second limiting portion 221 and the third limiting portion 132.

It can be understood that the first limiting portion 131 is the first groove 101, the third limiting portion 132 is the second groove 105, and the second limiting portion 221 is the first protrusion 221, which enables the first clamping member 200a to quickly locate the second position and the first ready-to-clamp position during rotation.

It can be understood that the first protrusion 221 is adapted to the first groove 101, and the first protrusion 221 is adapted to the second groove 105.

It can be understood that the first protrusion 221 engaged in the first groove 101 can stably maintain the first clamping member 200a at the second position.

It can be understood that the first protrusion 221 engaged in the second groove 105 can stably maintain the first clamping member 200a at the first ready-to-clamp position.

For example, the first clamping member 200a can be rotated from the second position to a first ready-to-clamp position relative to the bearing body 100. The first clamping member 200a can be extended from the first ready-to-clamp position to the first position. When the first clamping member 200a is at the first ready-to-clamp position relative to the bearing body 100, the first clamping member 200a is retracted into the bearing body 100. When the first clamping member 200a is at the first position relative to the bearing body 100, the first clamping member 200a clamps the electronic terminal. During the process where the first clamping member 200a is rotated from the second position to the first ready-to-clamp position, the first protrusion 221 and the second groove 105 transition from the disengaged state to the engaged state. The first protrusion 221 and the second groove 105 being in the engaged state enables the first clamping member 200a to be maintained at the first ready-to-clamp position relative to the bearing body 100. During the process where the first clamping member 200a is rotated from the first ready-to-clamp position to the second position, the first protrusion 221 and the second groove 105 transition from the engaged state to the disengaged state. The first groove 101 is in an open shape, the second groove 105 is in an open shape, and the first groove 101 intersects with the second groove 105.

In other embodiments, the first limiting portion 131 is a protrusion, the third limiting portion 132 is a protrusion, and the second limiting portion 221 is a groove.

In some embodiments of the present disclosure, referring to FIGS. 9, 10, and 11, the first groove 101 is in an open shape, and the second groove 105 is in an open shape. The first groove 101 extends in a direction parallel to a first straight line, and the cross-section of the first groove 101 is V-shaped. The first protrusion 221 is cylindrical. When the first limiting portion 131 and the second limiting portion 221 are in the engaged state, the extending direction of the first protrusion 221 is parallel to the first straight line. The second groove 105 extends in a direction parallel to a second straight line, the first groove 101 intersects with the second groove 105, and the cross-section of the second groove 105 is V-shaped. When the second limiting portion 221 and the third limiting portion 132 are in the engaged state, the extending direction of the first protrusion 221 is parallel to the second straight line.

It can be understood that setting the first groove 101 and the second groove 105 in an open shape facilitates the first protrusion 221 and the first groove 101 transitioning from the engaged state to the disengaged state (or the first protrusion 221 and the second groove 105 transitioning from the engaged state to the disengaged state). On the other hand, during the rotation of the first clamping member 200a relative to the bearing body 100, the first protrusion 221 is less likely to damage the first groove 101, and the first protrusion 221 is less likely to damage the second groove 105.

It can be understood that the first groove 101 being in an open shape means that the first groove 101 has a first opening 101a, and the cross-section of the first groove 101 increases from a bottom wall of the first groove 101 to the first opening 101a.

It can be understood that the second groove 105 being in an open shape means that the second groove 105 has a second opening, and the cross-section of the second groove 105 increases from a bottom wall of the second groove 105 to the second opening.

It can be understood that the cross-section of the first groove 101 is perpendicular to the first straight line, and the cross-section of the second groove 105 is perpendicular to the second straight line.

It can be understood that the first groove 101 and the second groove 105 are both V-shaped, and the first protrusion 221 is cylindrical. The tolerance of the diameter size of the first protrusion 221 does not affect the first protrusion 221 and the first groove 101 being in the engaged state.

For example, the first groove 101 intersects with the second groove 105.

For example, the second straight line and the second straight line have a first included angle, which may be 90°, 75°, 60°, 45°, etc.

In other examples, the first groove 101, the second groove 105, and the first protrusion 221 all extend along the same curve. For example, the extension trajectories of the first groove 101, the second groove 105, and the first protrusion 221 are all S-shaped.

For example, from the bottom wall of the first groove 101 to the first opening 101a, the cross-section of the first groove 101 gradually increases. From the bottom wall of the second groove 105 to the second opening, the cross-section of the second groove 105 gradually increases. The first groove 101 is semicircular, and the second groove 105 is semicircular; or the first groove 101 is V-shaped, and the second groove 105 is V-shaped.

In other examples, from the bottom wall of the first groove 101 to the first opening 101a, the cross-section of the first groove 101 remains unchanged. From the bottom wall of the second groove 105 to the second opening, the cross-section of the second groove 105 remains unchanged. The first groove 101 is U-shaped, and the second groove 105 is U-shaped.

In other examples, the first groove 101 and the second groove 105 cross.

In other examples, the first protrusion 221 is columnar, such as a square column or a polygonal column.

In other embodiments, the first limiting portion 131 and the third limiting portion 132 are both protrusions, and the second limiting portion 221 is an adapted groove.

In some embodiments of the present disclosure, referring to FIGS. 9, 10, and 11, during the process where the first clamping member 200a slides from the first ready-to-clamp position to the first position, the second limiting portion 221 and the third limiting portion 132 remain in the engaged state. The advantage of this arrangement is that when the user adjusts the first clamping member 200a from the first ready-to-clamp position to the first position, the first clamping member 200a is less likely to shake relative to the bearing body 100.

In some embodiments of the present disclosure, referring to FIGS. 7, 8, 16, etc., the bearing body 100 includes a first positioning portion 161 corresponding to each first clamping member 200a. The first clamping member 200a includes a second positioning portion 211 adapted to the first positioning portion 161. During the process where the first clamping member 200a moves from the first position to the second position, the second positioning portion 211 and the first positioning portion 161 transition from a disengaged state to an engaged state. The first positioning portion 161 and the second positioning portion 211 being in the engaged state enable the first clamping member 200a to be maintained at the second position relative to the bearing body 100. During the process where the first clamping member 200a moves from the second position to the first position, the second positioning portion 211 and the first positioning portion 161 transition from the engaged state to the disengaged state.

It can be understood that the first positioning portion 161 and the second positioning portion 211 being in the engaged state enable the first clamping member 200a to be stably maintained at the second position.

For example, during the process where the first positioning portion 161 and the second positioning portion 211 transition from the disengaged state to the engaged state or from the engaged state to the disengaged state, the first clamping member is axially stationary relative to the first main body, and the first positioning portion 161 or the second positioning portion 211 undergoes elastic deformation to enable the first positioning portion 161 and the second positioning portion 211 to transition from the disengaged state to the engaged state or from the engaged state to the disengaged state.

For example, during the process where the first positioning portion 161 and the second positioning portion 211 transition from the disengaged state to the engaged state or from the engaged state to the disengaged state, the first clamping member 200a elastically extends or retracts axially relative to the first main body 110 to enable the first positioning portion 161 and the second positioning portion 211 to transition from the disengaged state to the engaged state or from the engaged state to the disengaged state.

It should be understood that the number of first positioning portions 161 is the same as the number of first clamping members 200a.

In some embodiments of the present disclosure, referring to FIGS. 7, 8, 16, etc., the first positioning portion 161 is a second protrusion 161, and the second positioning portion 211 is a third groove 202; or, the first positioning portion 161 is a third groove 202, and the second positioning portion 211 is a second protrusion 161. The second protrusion 161 is engaged in the third groove 202 to achieve the engaged state between the second positioning portion 211 and the first positioning portion 161.

It can be understood that the second protrusion 161 engaged in the third groove 202 may more stably maintain the first clamping member 200a at the second position.

In other examples, the first positioning portion 161 and the second positioning portion 211 are both protrusions. The first positioning portion 161 abuts against the second positioning portion 211, or the first positioning portion 161 and the second positioning portion 211 are in tight cooperation.

In some embodiments of the present disclosure, referring to FIGS. 7, 8, 16, etc., the first clamping member 200a is rotatably arranged on the bearing body 100 about a first axis. The first clamping member 200a is elastically retractable relative to the bearing body 100 in a direction parallel to the first axis. The elastic retractability of the first clamping member 200a relative to the bearing body 100 can change the clamping width of the bearing device 1. When the first clamping member 200a is at the second position relative to the bearing body 100, the first clamping member 200a is retracted into the bearing body 100. The first positioning portion 161 includes at least one second protrusion, and the second positioning portion 211 includes at least one third groove; or, the first positioning portion 161 includes at least one third groove, and the second positioning portion 211 includes at least one second protrusion. The number of the at least one second protrusion 161 is two, and the two second protrusions 161 are disposed on opposite sides of the first axis. The number of the at least one third groove 202 is two, and the two third grooves 202 are disposed on opposite sides of the first axis. Each second protrusion 161 has two first side walls 161a, and the distance between the two first side walls 161a narrows from a bottom end to a top end of the second protrusion 161. During a process where the first clamping member 200a rotates into or out of the second position relative to the bearing body 100, the first clamping member 200a slides over the first side wall 161a.

It can be understood that the first clamping member 200a is elastically retractable relative to the bearing body 100. During the user's rotation of the first clamping member 200a, the second protrusion 161 and the third groove 202 transition from the disengaged state to the engaged state, or the second protrusion 161 and the third groove 202 transition from the engaged state to the disengaged state. During the process where the second protrusion 161 and the third groove 202 transition from the disengaged state to the engaged state or from the engaged state to the disengaged state, the first clamping member 200a is elastically retractable relative to the bearing body 100.

It can be understood that the distance between the two first side walls 161a narrowing from the bottom end to the top end of the second protrusion 161 facilitates the user's rotation of the first clamping member 200a, enabling the second protrusion 161 and the third groove 202 to transition from the disengaged state to the engaged state or from the engaged state to the disengaged state.

It can be understood that setting the number of second protrusions 161 and second grooves 105 to two enables the first clamping member 200a to be more stably maintained at the second position.

It can be understood that during the process where the first clamping member 200a rotates out of the second position relative to the bearing body 100, an inner side wall of the third groove 202 slides over the first side wall 161a.

It can be understood that during the process where the first clamping member 200a rotates into the second position relative to the bearing body 100, an outer wall of the first clamping member 200a slides over the first side wall 161a.

In some embodiments of the present disclosure, referring to FIGS. 7, 8, 16, etc., the first clamping member 200a includes a third positioning portion 212, and the third positioning portion 212 is adapted to the first positioning portion 161. The first clamping member 200a is rotatably arranged on the bearing body 100 about a first axis. The first clamping member 200a is elastically retractable relative to the bearing body 100 in a direction parallel to the first axis. The elastic retractability of the first clamping member 200a relative to the bearing body 100 can change the clamping width of the bearing device 1. When the first clamping member 200 a is at the second position relative to the bearing body 100, the first clamping member 200a is retracted into the bearing body 100. The first clamping member 200a can be rotated from the second position to the first ready-to-clamp position relative to the bearing body 100. The first clamping member 200a can be extended from the first ready-to-clamp position to the first position. During the process where the first clamping member 200a is rotated from the second position to the first ready-to-clamp position, the first positioning portion 161 and the third positioning portion 212 transition from the disengaged state to the engaged state. The first positioning portion 161 and the third positioning portion 212 being in the engaged state enable the first clamping member 200a to be maintained at the first ready-to-clamp position relative to the bearing body 100. During the process where the first clamping member 200a is rotated from the first ready-to-clamp position to the second position, the first positioning portion 161 and the third positioning portion 212 transition from the engaged state to the disengaged state.

It can be understood that the first clamping member 200a being maintained at the first ready-to-clamp position may prevent the first clamping member 200a from shaking at the first ready-to-clamp position and prevent the first clamping member 200a from returning to the second position from the first ready-to-clamp position. When the first clamping member 200a is required to clamp the electronic terminal, it is convenient to adjust the first clamping member 200a from the first ready-to-clamp position to the first position. For example, when the first clamping member 200a is maintained at the first ready-to-clamp position, the electronic terminal may be operated to push the first clamping member 200a, moving the first clamping member 200a to the first position.

For example, the first positioning portion 161 is a protrusion, and the third positioning portion 212 is a groove; or, the first positioning portion 161 is a groove, and the third positioning portion 212 is a protrusion.

In other examples, the first positioning portion 161 and the third positioning portion 212 are both protrusions. The first positioning portion 161 abuts against the third positioning portion 212, or the first positioning portion 161 and the third positioning portion 212 are in tight cooperation, to maintain the first clamping member 200a at the first ready-to-clamp position.

In some embodiments of the present disclosure, referring to FIGS. 7, 8, 16, etc., the first positioning portion 161 includes at least one second protrusion 161, the second positioning portion 211 includes at least one third groove 202, and the third positioning portion 212 includes at least one fourth groove 203. The second protrusion 161 is engaged in the third groove 202 to achieve the engaged state between the first positioning portion 161 and the second positioning portion 211. The second protrusion 161 is engaged in the fourth groove 203 to achieve the engaged state between the first positioning portion 161 and the third positioning portion 212. The number of the at least one second protrusion 161, the at least one third groove 202, and the at least one fourth groove 203 is two each. The two second protrusions 161 are disposed on opposite sides of the first axis. The two third grooves 202 are disposed on opposite sides of the first axis. The two fourth grooves 203 are disposed on opposite sides of the first axis. Each second protrusion 161 has two first side walls 161a, and the distance between the two first side walls 161a narrows from a bottom end to a top end of the second protrusion 161. During a process where the first clamping member 200a rotates into or out of the second position relative to the bearing body 100, the first clamping member 200a slides over the first side wall 161a. During a process where the first clamping member 200a rotates into or out of the first ready-to-clamp position relative to the bearing body 100, the first clamping member 200a slides over the first side wall 161a.

It can be understood that the first clamping member 200a is elastically retractable relative to the bearing body 100. During the user's rotation of the first clamping member 200a, the second protrusion 161 and the third groove 202 transition from the disengaged state to the engaged state or from the engaged state to the disengaged state, and the second protrusion 161 and the fourth groove 203 transition from the disengaged state to the engaged state or from the engaged state to the disengaged state. During the process where the second protrusion 161 and the third groove 202 transition from the disengaged state to the engaged state or from the engaged state to the disengaged state, the first clamping member 200a elastically extends or retracts relative to the bearing body 100. During the process where the second protrusion 161 and the third groove 202 transition from the disengaged state to the engaged state or from the engaged state to the disengaged state, the first clamping member 200a elastically extends or retracts relative to the bearing body 100.

It can be understood that the distance between the two first side walls 161a narrowing from the bottom end to the top end of the second protrusion 161 facilitates the user's rotation of the first clamping member 200a, enabling the second protrusion 161 and the third groove 202 to transition from the disengaged state to the engaged state or from the engaged state to the disengaged state, and enabling the second protrusion 161 and the fourth groove 203 to transition from the disengaged state to the engaged state or from the engaged state to the disengaged state.

It can be understood that setting the number of second protrusions 161, second grooves 105, and third grooves 202 to two each enables the first clamping member 200a to be more stably maintained at the second position and at the first ready-to-clamp position.

It can be understood that during the process where the first clamping member 200a rotates out of the second position relative to the bearing body 100, an inner side wall of the third groove 202 slides over the first side wall 161a.

It can be understood that during the process where the first clamping member 200a rotates into the second position relative to the bearing body 100, an outer wall of the first clamping member 200a slides over the first side wall 161a.

It can be understood that during the process where the first clamping member 200a rotates out of the first ready-to-clamp position relative to the bearing body 100, an inner side wall of the fourth groove 203 slides over the first side wall 161a.

It can be understood that during the process where the first clamping member 200a rotates into the first ready-to-clamp position relative to the bearing body 100, the outer wall of the first clamping member 200a slides over the first side wall 161a.

In other embodiments, the first positioning portion 161 is a groove, and the second positioning portion 211 and the third positioning portion 212 are protrusions.

In some embodiments of the present disclosure, referring to FIG. 1, when the first clamping member 200a is at the second position relative to the bearing body 100 and the magnetic member 120 magnetically attracts the electronic terminal, the first clamping member 200a and the bearing body 100 are disposed on the same side of the electronic terminal.

It can be understood that the first clamping member 200a and the bearing body 100 being disposed on the same side of the electronic terminal enables the electronic terminal to be placed on the bearing body 100 without obstruction.

For example, when the first clamping member 200a is at the second position relative to the bearing body 100 and the magnetic member 120 magnetically attracts the electronic terminal, the first clamping member 200a and the bearing body 100 are disposed on a back side of the electronic terminal.

For example, when the first clamping member 200a is at the second position relative to the bearing body 100 and the magnetic member 120 magnetically attracts the electronic terminal, the first clamping member 200a and the bearing body 100 are disposed on a front side of the electronic terminal.

In some embodiments of the present disclosure, referring to FIGS. 1, 7, 8, etc., the first clamping member 200a includes a first clamping portion 210. The first clamping portion 210 is configured to clamp the electronic terminal. The first clamping portion 210 has a first abutting wall 201. When the first clamping portion 210 clamps the electronic terminal, the first abutting wall 201 abuts against the electronic terminal. When the first clamping member 200a is at the second position relative to the bearing body 100, the first abutting wall 201 of the first clamping portion 210 is close to or attached to the bearing body 100.

When the first clamping member 200a clamps the electronic terminal, the first clamping portion 210 protrudes from the bearing surface 109 of the bearing body 100. When the first abutting wall 201 is close to or attached to the bearing body 100, the bearing device 1 becomes easy to store, and the terminal holder containing this bearing device 1 also becomes easy to store.

It should be understood that the first abutting wall 201 abutting against the electronic terminal may further help keep the first clamping member 200 at the first position.

For example, when the first abutting wall 201 is close to the bearing body 100, there is a gap between the first abutting wall 201 and the bearing body 100.

For example, when the first abutting wall 201 is attached to the bearing body 100, the first abutting wall 201 may be completely attached to the bearing body 100, or the first abutting wall 201 may be partially attached to the bearing body 100.

For example, the bearing body 100 has a first peripheral wall 107 corresponding to the first clamping member 200a. When the first clamping portion 210 is at the second position relative to the bearing body 100, the first clamping portion 210 is stacked on the first peripheral wall 107, and the first abutting wall 201 is attached to or close to the first peripheral wall 107.

In some embodiments of the present disclosure, referring to FIGS. 1, 7, 8, etc., the bearing body 100 has a first peripheral wall 107 corresponding to each first clamping member 200a. The bearing body 100 has a first peripheral space 108 adjacent to the first peripheral wall 107. The first clamping member 200a includes a rotating connection portion 220 and a first clamping portion 210. The rotating connection portion 220 is rotatably arranged on the bearing body 100. The first clamping portion 210 is rotatably arranged on the bearing body 100. The first clamping portion 210 is configured to clamp the electronic terminal. When the first clamping member 200a is at the second position relative to the bearing body 100, the first clamping portion 210 is disposed in the first peripheral space 108 of the bearing body 100.

It should be understood that the first clamping portion 210 being disposed within the first peripheral space 108 of the bearing body 100 may prevent the first clamping portion 210 from obstructing the placement of the electronic terminal on the bearing body 100.

It should be understood that the number of first peripheral walls 107 is the same as the number of first clamping members 200a.

For example, the rotating connection portion 220 has one or two rotational degrees of freedom relative to the bearing body 100.

For example, the first clamping member 200a is rotatably connected to the first peripheral wall 107.

For example, the second connection hole 104 communicates with the first peripheral space 108.

In some embodiments of the present disclosure, referring to FIGS. 1, 7, 8, etc., when the first clamping member 200a is at the second position relative to the bearing body 100, the first clamping portion 210 is stacked on the first peripheral wall 107. The first clamping portion 210 has a first abutting wall 201. When the first clamping portion 210 clamps the electronic terminal, the first abutting wall 201 abuts against the electronic terminal. When the first clamping member 200a is at the second position relative to the bearing body 100, the first abutting wall 201 is close to or attached to the first peripheral wall 107 of the bearing body 100.

It can be understood that, when the first clamping member 200a is at the second position, the first abutting wall 201 being close to or attached to the first peripheral wall 107 may make the structure of the bearing device 1 more compact, occupy a smaller volume, and facilitate the use or storage of the bearing device 1.

In some embodiments of the present disclosure, referring to FIGS. 1, 7, 8, 15, etc., the rotating connection portion 220 is rotatably arranged on the bearing body 100 about the first axis. The first peripheral wall 107 includes a first sub-wall 107a and a second sub-wall 107b. The first sub-wall 107a and the second sub-wall 107b are disposed on opposite sides of the first axis, respectively. When the first clamping member 200a is at the second position relative to the bearing body 100, the first abutting wall 201 is close to or attached to the first sub-wall 107a of the bearing body 100, or the first abutting wall 201 is close to or attached to the second sub-wall 107b of the bearing body 100.

It can be understood that the provision of the first sub-wall 107a and the second sub-wall 107b gives the first clamping member 200a two options for returning to the second position, thereby further facilitating the use of the bearing device 1.

For example, the first abutting wall 201 is a plane, and the first sub-wall 107a and the second sub-wall 107b are both planes.

For example, the first abutting wall 201 is a curved surface, and the first sub-wall 107a and the second sub-wall 107b are both curved surfaces. For example, the first abutting wall 201 is an arc surface, and the first sub-wall 107a and the second sub-wall 107b are both arc surfaces.

In some embodiments of the present disclosure, referring to FIGS. 1, 7, 8, 16, etc., the rotating connection portion 220 is rotatably arranged on the bearing body 100 about the first axis. The rotating connection portion 220 is retractable (extends/retracts) relative to the bearing body 100 in a direction parallel to the first axis. The first abutting wall 201 is adapted to the first peripheral wall 107. When the first clamping member 200a is at the second position relative to the bearing body 100, the first abutting wall 201 is attached to the first peripheral wall 107.

The advantage of this arrangement is that when the first abutting wall 201 is not rotationally symmetric about the first axis, the first clamping member 200a is retractable along the direction of the first axis, facilitating the attachment of the first abutting wall 201 to the first peripheral wall 107.

For example, the first abutting wall 201 and the first peripheral wall 107 are planes. The first axis is not perpendicular to the first abutting wall 201, and the first axis is not perpendicular to the first peripheral wall 107. During the process of the first clamping member 200a rotating to the first position, the first clamping member 200a extends or retracts relative to the bearing body 100.

For example, the first abutting wall 201 is a cylindrical surface that is not rotationally symmetric about the first axis, and the first peripheral wall 107 is a cylindrical surface that is not rotationally symmetric about the first axis. During the process of the first clamping member 200a rotating to the first position, the first clamping member 200a extends or retracts relative to the bearing body 100.

In other examples, the first abutting wall 201 is rotationally symmetric about the first axis, and the first peripheral wall 107 is rotationally symmetric about the first axis. This enables the first abutting wall 201 to better attach to the first peripheral wall 107 during the process of the first clamping member 200a rotating to the second position. For example, the first abutting wall 201 is a spherical surface rotationally symmetric about the first axis, and the first peripheral wall 107 is a spherical surface rotationally symmetric about the first axis. The advantage of this arrangement is that it facilitates the rotation of the first clamping member 200a to the second position.

In some embodiments of the present disclosure, both the clamping members 200 are the first clamping members 200a. A first plane is defined perpendicular to the clamping direction of the two clamping members 200, and the first plane is disposed between the two clamping members 200. When the first clamping member 200a is at the first position relative to the bearing body 100, a bottom end of the first abutting wall 201 is close to the bearing body 100, and a top end of the first abutting wall 201 is away from the bearing body 100. From the bottom end to the top end of the first abutting wall 201, the first abutting wall 201 gradually approaches the first plane.

The advantage of this arrangement is that when the two first clamping members 200a clamp the electronic terminal, the electronic terminal is less likely to disengage from the first clamping members 200a, and the electronic terminal has a tendency to move closer to the bearing body 100.

For example, the first abutting wall 201 is a plane inclined relative to the bearing surface 109.

For example, the first abutting wall 201 is a partial cylindrical surface.

In some embodiments of the present disclosure, both the clamping members 200 are the first clamping members 200a.

It can be understood that when both the clamping members 200 are the first clamping members 200a, and when both the first clamping members 200a are at the second positions relative to the bearing body 100, the electronic terminal can be more freely placed on the bearing body 100. Furthermore, it is convenient to adjust the orientation of the electronic terminal, for example, to place the electronic terminal in a landscape orientation, a tilted orientation, or a portrait orientation.

For example, the first axes of the two first clamping members 200a are coaxial.

For example, the first axes of the two first clamping members 200a are parallel.

Specifically, the first magnetic member 120 has a ring-shaped structure. For example, the first magnetic member 120 is circular; or the first magnetic member 120 includes multiple magnetic sub-components, and the magnetic sub-components are evenly distributed in a ring shape. The advantage of this arrangement is that it enables the first magnetic member 120 to better attract the electronic terminal when the electronic terminal is in different orientations.

Specifically, the first magnetic member 120 is a ring-shaped structure close to the periphery of the bearing body 100.

In other embodiments, the bearing body 100 defines an accommodation groove. When the first clamping member 200a is at the second position relative to the bearing body 100, the first clamping portion 210 of the first clamping member 200a is accommodated in the accommodation groove.

It should be understood that when describing the positional or connection relationships between various components such as the first limiting portion 131, the second limiting portion 221, the first slidable member 130, the first elastic element 140, the first sliding groove 103, the first connection hole 102, the second connection hole 104, the first wall body 111, the third limiting portion 132, the first positioning portion 161, the second positioning portion 211, and the third positioning portion 212 in the embodiments of the present disclosure, these components are those corresponding to a same first clamping member 200a.

Specifically, the first main body 110 may include a first housing 150, a second housing 160, and a magnetic member 120. The second housing 160 is arranged on the first housing 150. Specifically, the first housing 150 is detachably arranged on the second housing 160. The first main body 110 has a first accommodation space 1010 for accommodating the magnetic member 120. The first accommodation space 1010 is defined on the first housing 150 or the second housing 160, or the first accommodation space 1010 is disposed between the first housing 150 and the second housing 160.

Specifically, the bearing surface 109 is disposed on the first housing 150. The first positioning portion 161 is arranged on the second housing 160.

Specifically, the first sliding groove 103 includes a first sub-groove 103a and a second sub-groove 103b. The first sub-groove 103a is defined on the first housing 150, and the second sub-groove 103b is defined on the second housing 160. The first sub-groove 103a and the second sub-groove 103b together enclose and form the first sliding groove 103. This arrangement facilitates the manufacturing of the first main body 110.

Specifically, the first housing 150 is snap-connected to the second housing 160. The first housing 150 is arranged, from the inside to the outside, with multiple first snap portions 151, multiple second snap portions 152, and multiple third snap portions 153. The second housing 160 is arranged, from the inside to the outside, with multiple fourth snap portions 163, multiple fifth snap portions 164, and multiple sixth snap portions 165. The multiple fourth snap portions 163 correspond to the multiple first snap portions 151, respectively. The multiple fifth snap portions 164 correspond to the multiple second snap portions 152, respectively. The multiple sixth snap portions 165 correspond to the multiple third snap portions 153, respectively. The above arrangement enables the first housing 150 to be stably installed on the second housing 160.

More specifically, the first main body 110 is disk-shaped. Along its thickness direction, the first main body 110 has a second axis. The first main body 110 is rotationally symmetric about the second axis. The multiple first snap portions 151 are rotationally symmetric about the second axis. The multiple second snap portions 152 are rotationally symmetric about the second axis. The multiple third snap portions 153 are rotationally symmetric about the second axis. The multiple fourth snap portions 163 are rotationally symmetric about the second axis. The multiple fifth snap portions 164 are rotationally symmetric about the second axis. The multiple sixth snap portions 165 are rotationally symmetric about the second axis.

More specifically, the number of first clamping members 200a may be two. When the two first clamping members 200a clamp the electronic terminal, the two first clamping members 200a are centrally symmetric about the second axis.

In some implementations, the magnetic member 120 has a ring-shaped structure. The advantage of this arrangement is that when adjusting the orientation of the electronic terminal, the electronic terminal can still be well attracted. The orientation of the electronic terminal can be landscape, portrait, tilted, etc.

Specifically, the second connection hole 104 includes a first connection sub-groove 104a and a second connection sub-groove 104b. The first connection sub-groove 104a is defined on the first housing 150, and the second connection sub-groove 104b is defined on the second housing 160. The first connection sub-groove 104a and the second connection sub-groove 104b together enclose and form the second connection hole 104. This arrangement facilitates the manufacturing and installation of the bearing device 1.

Specifically, the first wall body 111 includes a first sub-wall body 111a and a second sub-wall body 111b. The first sub-wall body 111a and the second sub-wall body 111b are disposed on the first housing 150 and the second housing 160, respectively. The first connection sub-groove 104a is defined on the first sub-wall body 111a, and the second connection sub-groove 104b is defined on the second sub-wall body 111b.

Referring to FIG. 18, the present disclosure further proposes a terminal holder, including a support device 2 and a bearing device 1. The bearing device 1 is arranged on the support device 2.

For example, the support device 2 may be a plate-type support device 2. For example, the support device 2 includes a support rod 21 and a support plate. The support rod 21 is arranged on the support plate. The support plate may be placed on the ground, a desktop, etc. The support rod 21 may be a length-adjustable rod or a length-fixed rod, etc. The bearing device 1 is arranged on the support rod 21.

For example, the support device 2 may be a multi-legged support device 2. For example, the support device 2 includes a support rod 21 and multiple support feet 22. The support rod 21 is arranged on the multiple support feet 22. There may be at least 3 support feet provided. The support feet 22 may be placed on the ground, a desktop, etc. The support rod 21 may be a length-adjustable rod or a length-fixed rod, etc. The bearing device 1 is arranged on the support rod 21.

For example, the support device 2 may be a suction cup-type support device 2. For example, the support device 2 includes a support rod 21 and a suction cup. The suction cup can be adsorbed onto a support surface. The bearing device 1 is arranged on the support rod 21.

For example, the support device 2 may be a clamping-type support device 2.

Referring to FIGS. 1 to 17, some embodiments of the present disclosure further propose a connection structure. The connection structure is applied to a bearing device 1. The bearing device 1 is configured to clamp an electronic terminal. The bearing device 1 includes a bearing body 100 and two clamping members 200. The two clamping members 200 are arranged on the bearing body 100. The two clamping members 200 cooperate to clamp the electronic terminal. At least one of the two clamping members 200 is a first clamping member 200a. The connection structure includes a bearing body 100 and a first clamping member 200a. The first clamping member 200a is rotatably connected to the bearing body 100. Rotating the first clamping member 200a can cause the first clamping member 200a to be disposed at different positions relative to the bearing body 100.

It can be understood that this connection structure is applied to the bearing device 1. When the bearing device 1 is required to be stored, the first clamping member 200a can be rotated such that it is disposed at a different position relative to the bearing body 100, facilitating the storage of the bearing device 1 or the terminal holder. For example, rotating the first clamping member 200a enables it to be stored in a suitable posture within a storage space.

It can be understood that in the embodiments of the present disclosure, the bearing device 1 may be a fixture 1.

For example, the first clamping member 200a can rotate fully around the bearing body 100.

Referring to FIGS. 1 to 17, some embodiments of the present disclosure further propose a fixture 1, including a bearing body 100 and two clamping members 200. The two clamping members 200 are arranged on the bearing body 100. The two clamping members 200 are configured to cooperate to clamp an electronic terminal. Both the clamping members 200 are first clamping members 200a. The first clamping member 200a is rotatably connected to the bearing body 100. Rotating the first clamping member 200a can cause the first clamping member 200a to be disposed at different positions relative to the bearing body 100. Each first clamping member 200a and the bearing body 100 form a connection structure.

It can be understood that when the fixture 1 is required to be stored, both the first clamping members 200a can be rotated such that they are disposed at different positions relative to the bearing body 100, facilitating the storage of the fixture 1 or the terminal holder. For example, rotating the first clamping member 200a enables it to be stored in a suitable posture within a storage space.

Referring to FIGS. 1 to 17, some embodiments of the present disclosure further propose a fixture 1 for clamping an electronic terminal, where the fixture 1 includes a bearing body 100 and two clamping members 200. The two clamping members 200 are arranged on the bearing body 100. The two clamping members 200 are configured to cooperate to clamp the electronic terminal. At least one of the two clamping members 200 is a first clamping member 200a. The first clamping member 200a is rotatably connected to the bearing body 100. The first clamping portion 210 includes a rotating connection portion 220 and a first clamping portion 210. The rotating connection portion 220 is rotatably arranged on the bearing body 100. The first clamping portion 210 is arranged on the rotating connection portion 220. Rotating the first clamping member 200a can cause the first clamping portion 210 to be stacked on the bearing body 100.

It can be understood that when the fixture 1 is required to be stored, the first clamping member 200a can be rotated such that it is stacked on the bearing body 100, thereby reducing the volume occupied by the bearing device 1 and facilitating the storage of the bearing device 1 or the terminal holder.

The above description is only intended to illustrate the technical solutions of the present disclosure and not to limit the same. Other modifications or equivalent replacements made to the technical solutions of the present disclosure by those skilled in the art, without departing from the spirit and scope of the technical solutions of the present disclosure, shall be covered within the scope of the claims of the present disclosure.

What is claimed is:

1. A bearing device, configured to bear an electronic terminal and comprising a bearing body and two clamping members;
wherein the bearing body is arranged with a magnetic member for magnetically attracting the electronic terminal;
the two clamping members are both arranged on the bearing body, and the two clamping members are configured to cooperate to clamp the electronic terminal;
at least one of the two clamping members is a first clamping member, and the first clamping member is rotatably connected to the bearing body; in a case where the bearing device clamps the electronic terminal, the first clamping member is disposed at a first position relative to the bearing body; the first clamping member is capable of moving to a second position relative to the bearing body, and the first clamping member is capable of being maintained at the second position relative to the bearing body;
wherein, in a case where the two clamping members clamp the electronic terminal, the magnetic member is configured to magnetically attract the electronic terminal; in a case where the first clamping member is at the second position relative to the bearing body, the electronic terminal is capable of being placed on the bearing body, causing the magnetic member to magnetically attract the electronic terminal.

2. The bearing device according to claim 1, wherein the bearing body comprises a first limiting portion corresponding to each first clamping member, and the first clamping member comprises a second limiting portion adapted to the first limiting portion;
during a process where the first clamping member moves from the first position to the second position, the second limiting portion and the first limiting portion transition from a disengaged state to an engaged state, and the second limiting portion and the first limiting portion being in the engaged state enables the first clamping member to be maintained at the second position relative to the bearing body;
during a process where the first clamping member moves from the second position to the first position, the second limiting portion and the first limiting portion transition from the engaged state to the disengaged state.

3. The bearing device according to claim 2, wherein the bearing body comprises a first main body, and the bearing body further comprises a first slidable member and a first elastic element corresponding to the first clamping member;
the first slidable member is slidably arranged on the first main body, and the first limiting portion is arranged on the first slidable member; an end of the first elastic element acts on the first main body, and another end of the first elastic element acts on the first slidable member; the first elastic element is configured to cause the first slidable member to abut against the first clamping member;
wherein in a case where the first clamping member is at the second position relative to the bearing body, the first elastic element causes the first limiting portion and the second limiting portion to be in the engaged state;
during a process where the first limiting portion and the second limiting portion transition from the engaged state to the disengaged state or from the disengaged state to the engaged state, the first slidable member slides relative to the first clamping member.

4. The bearing device according to claim 3, wherein the first limiting portion is a first groove, and the second limiting portion is a first protrusion; or, the first limiting portion is the first protrusion, and the second limiting portion is the first groove;
the first protrusion is engaged in the first groove to achieve the engaged state between the first limiting portion and the second limiting portion.

5. The bearing device according to claim 4, wherein the first groove has a first opening; a cross-section of the first groove increases from a bottom wall of the first groove to the first opening.

6. The bearing device according to claim 5, wherein the first groove extends in a direction parallel to a first straight line, and the cross-section of the first groove is V-shaped; the first protrusion is cylindrical; in a case where the first limiting portion and the second limiting portion are in the engaged state, an extending direction of the first protrusion is parallel to the first straight line.

7. The bearing device according to claim 3, wherein the first clamping member is rotatably arranged on the bearing body about a first axis, the first slidable member is slidably arranged on the first main body in a direction parallel to the first axis, and the first slidable member is peripherally fixed relative to the first main body about the first axis;
the first clamping member is slidably arranged on the bearing body in the direction parallel to the first axis, and the first elastic element is configured to cause the first slidable member to abut against the first clamping member;
wherein in a case where the bearing device is not clamping the electronic terminal, the first elastic element is configured to cause the first slidable member to abut against the first clamping member, causing the first clamping member to be retracted into the bearing body; in a case where the first clamping member extends relative to the bearing body, the first elastic element is configured to cause the first slidable member to abut against the first clamping member, causing the first clamping member to have a clamping force for clamping the electronic terminal;
the first elastic element and the first slidable member are configured to enable the first clamping member to be elastically retractable in the direction parallel to the first axis; in a case where the first clamping member extends or retracts relative to the bearing body, a clamping width of the bearing device is changeable.

8. The bearing device according to claim 7, wherein the first clamping member is rotatably arranged on the first slidable member about the first axis, causing the first clamping member to be rotatably arranged on the bearing body about the first axis;
during a process where the first limiting portion and the second limiting portion transition from the disengaged state to the engaged state or from the engaged state to the disengaged state, the first slidable member slides relative to the first clamping member in the direction parallel to the first axis;
during a process where the first clamping member extends or retracts relative to the bearing body, the first slidable member always follows the first clamping member, causing the first clamping member to slide relative to the bearing body in the direction parallel to the first axis.

9. The bearing device according to claim 8, wherein the first clamping member comprises a first clamping portion and a rotating connection portion; the first clamping portion is configured to clamp the electronic terminal, the first clamping portion is arranged on the rotating connection portion, and the second limiting portion is arranged on the rotating connection portion;
the first slidable member defines a first connection hole, the rotating connection portion is sleeved in the first connection hole, and the rotating connection portion is rotatable relative to the first connection hole about the first axis, causing the first clamping member to be rotatably connected to the bearing body about the first axis;
during the process where the first limiting portion and the second limiting portion transition from the disengaged state to the engaged state or from the engaged state to the disengaged state, the first connection hole slides relative to the rotating connection portion in the direction parallel to the first axis;
during a process where the first clamping member slides relative to the bearing body in the direction parallel to the first axis, the first slidable member always follows the rotating connection portion.

10. The bearing device according to claim 9, wherein the first limiting portion is a first groove, the second limiting portion is a first protrusion, the first protrusion is engaged in the first groove to achieve the engaged state between the first limiting portion and the second limiting portion, and the first protrusion protrudes from the rotating connection portion;
wherein in a case where the first clamping member extends relative to the bearing body, the first protrusion pushes the first slidable member, causing the first slidable member to slide relative to the first main body; in a case where the first clamping member retracts relative to the bearing body, the first elastic element pushes the first slidable member, causing the first slidable member slides relative to the first main body.

11. The bearing device according to claim 9, wherein the first elastic element is a first spring, the first spring is helical, and the first spring surrounds the rotating connection portion;
the first main body defines a first sliding groove corresponding to the first clamping member, the first slidable member is slidably arranged in the first sliding groove, and the first spring is accommodated in the first sliding groove.

12. The bearing device according to claim 9, wherein the first main body defines a second connection hole corresponding to the first clamping member, and the second connection hole is coaxial with the first connection hole; the rotating connection portion is slidable relative to the second connection hole in the direction parallel to the first axis, and the rotating connection portion is rotatable relative to the second connection hole about the first axis.

13. The bearing device according to claim 12, wherein the first main body has a first wall body corresponding to the first clamping member, and the first wall body is spaced apart from the first slidable member; the first elastic element is disposed between the first wall body and the first slidable member; the end of the first elastic element acts on the first wall body, and the another end of the first elastic element acts on the first slidable member; the second connection hole is defined on the first wall body.

14. The bearing device according to claim 13, wherein the first elastic element is a first spring, the first spring is helical, and the first spring surrounds the rotating connection portion;
the first main body defines a first sliding groove corresponding to the first clamping member, the first slidable member is slidably arranged in the first sliding groove, and the first elastic element is accommodated in the first sliding groove;
the first spring is a compression spring, and in a case where the first clamping member extends relative to the bearing body, the first slidable member moves closer to the first wall body.

15. The bearing device according to claim 2, wherein the bearing body comprises a third limiting portion corresponding to the first clamping member, and the second limiting portion is adapted to the third limiting portion;
the first clamping member is rotatably arranged on the bearing body about a first axis, and the first clamping member is elastically retractable relative to the bearing body in a direction parallel to the first axis;
an elastic retractability of the first clamping member relative to the bearing body is capable of changing a clamping width of the bearing device;
the first clamping member is capable of rotating from the second position to a first ready-to-clamp position relative to the bearing body, and the first clamping member is capable of extending from the first ready-to-clamp position to the first position; in a case where the first clamping member is at the first ready-to-clamp position relative to the bearing body, the first clamping member is retracted into the bearing body;
during a process where the first clamping member rotates from the second position to the first ready-to-clamp position, the second limiting portion and the third limiting portion transition from a disengaged state to an engaged state, and the second limiting portion and the third limiting portion being in the engaged state enables the first clamping member to be maintained at the first ready-to-clamp position relative to the bearing body;
during a process where the first clamping member rotates from the first ready-to-clamp position to the second position, the third limiting portion and the second limiting portion transition from the engaged state to the disengaged state.

16. The bearing device according to claim 15, wherein the bearing body comprises a first main body, and the bearing body further comprises a first slidable member and a first elastic element corresponding to the first clamping member;
the first slidable member is slidably arranged on the first main body, the first limiting portion is arranged on the first slidable member, and the third limiting portion is arranged on the first slidable member;
an end of the first elastic element acts on the first main body, and another end of the first elastic element acts on the first slidable member; the first elastic element is configured to cause the first slidable member to abut against the first clamping member;
wherein in a case where the first clamping member is at the second position relative to the bearing body, the first elastic element causes the first limiting portion and the second limiting portion to be in the engaged state;
in a case where the first clamping member is at the first ready-to-clamp position relative to the bearing body, the first elastic element causes the third limiting portion to engage with the second limiting portion;
during a process where the first limiting portion and the second limiting portion transition from the engaged state to the disengaged state or from the disengaged state to the engaged state, the first slidable member slides relative to the first clamping member;
during a process where the third limiting portion and the second limiting portion transition from the engaged state to the disengaged state or from the disengaged state to the engaged state, the first slidable member slides relative to the first clamping member.

17. The bearing device according to claim 16, wherein the first clamping member comprises a first clamping portion and a rotating connection portion; the first clamping portion is configured to clamp the electronic terminal, and the first clamping portion is arranged on the rotating connection portion;
the rotating connection portion is rotatably arranged on the bearing body about the first axis, and the second limiting portion is arranged on the rotating connection portion.

18. The bearing device according to claim 16, wherein the first limiting portion is a first groove, the third limiting portion is a second groove, and the second limiting portion is a first protrusion;
the first protrusion is engaged in the first groove to achieve the engaged state between the second limiting portion and the first limiting portion, and the first protrusion is engaged in the second groove to achieve the engaged state between the second limiting portion and the third limiting portion.

19. The bearing device according to claim 18, wherein the first groove has a first opening; a cross-section of the first groove increases from a bottom wall of the first groove to the first opening;, the second groove has a second opening; a cross-section of the second groove increases from a bottom wall of the second groove to the second opening;
the first groove extends in a direction parallel to a first straight line, and the cross-section of the first groove is V-shaped; the first protrusion is cylindrical; in a case where the first limiting portion and the second limiting portion are in the engaged state, an extending direction of the first protrusion is parallel to the first straight line;
the second groove extends in a direction parallel to a second straight line, the first groove and the second groove intersect, and the cross-section of the second groove is V-shaped; in a case where the second limiting portion and the third limiting portion are in the engaged state, the extending direction of the first protrusion is parallel to the second straight line.

20. The bearing device according to claim 15, wherein during a process where the first clamping member slides from the first ready-to-clamp position to the first position, the second limiting portion and the third limiting portion remain in the engaged state.

21. The bearing device according to claim 1, wherein the bearing body comprises a first positioning portion corresponding to each first clamping member, and the first clamping member comprises a second positioning portion adapted to the first positioning portion;
during a process where the first clamping member moves from the first position to the second position, the second positioning portion and the first positioning portion transition from a disengaged state to an engaged state, and the first positioning portion and the second positioning portion being in the engaged state enables the first clamping member to be maintained at the second position relative to the bearing body;
during a process where the first clamping member moves from the second position to the first position, the second positioning portion and the first positioning portion transition from the engaged state to the disengaged state.

22. The bearing device according to claim 21, wherein the first positioning portion comprises at least one second protrusion, and the second positioning portion comprises at least one third groove; or, the first positioning portion comprises the at least one third groove, and the second positioning portion comprises the at least one second protrusion;
each of the at least one second protrusion is engaged in a corresponding third groove to achieve the engaged state between the second positioning portion and the first positioning portion.

23. The bearing device according to claim 22, wherein the first clamping member is rotatably arranged on the bearing body about a first axis, and the first clamping member is elastically retractable relative to the bearing body in a direction parallel to the first axis; an elastic retractability of the first clamping member relative to the bearing body is capable of changing a clamping width of the bearing device; in a case where the first clamping member is at the second position relative to the bearing body, the first clamping member is retracted into the bearing body;
the at least one second protrusion is two second protrusions, and the at least one third groove is two third grooves; the two second protrusions are disposed on opposite sides of the first axis, and the two third grooves are disposed on opposite sides of the first axis;
the second protrusion has two first side walls, and a distance between the two first side walls narrows from a bottom end to a top end of the second protrusion; during a process where the first clamping member rotates into or out of the second position relative to the bearing body, the first clamping member slides over the first side walls.

24. The bearing device according to claim 21, wherein the first clamping member comprises a third positioning portion, and the third positioning portion is adapted to the first positioning portion;
the first clamping member is rotatably arranged on the bearing body about a first axis, and the first clamping member is elastically retractable relative to the bearing body in a direction parallel to the first axis;
an elastic retractability of the first clamping member relative to the bearing body is capable of changing a clamping width of the bearing device; in a case where the first clamping member is at the second position relative to the bearing body, the first clamping member is retracted into the bearing body;
the first clamping member is capable of rotating from the second position to a first ready-to-clamp position relative to the bearing body, and the first clamping member is capable of extending from the first ready-to-clamp position to the first position;
during a process where the first clamping member is rotated from the second position to the first ready-to-clamp position, the first positioning portion and the third positioning portion transition from a disengaged state to an engaged state, and the first positioning portion and the third positioning portion being in the engaged state enables the first clamping member to be maintained at the first ready-to-clamp position relative to the bearing body;
during a process where the first clamping member is rotated from the first ready-to-clamp position to the second position, the first positioning portion and the third positioning portion transition from the engaged state to the disengaged state.

25. The bearing device according to claim 24, wherein the first positioning portion comprises at least one second protrusion, the second positioning portion comprises at least one third groove, and the third positioning portion comprises at least one fourth groove; each of the at least one second protrusion is engaged in a corresponding third groove to achieve the engaged state between the first positioning portion and the second positioning portion; each of the at least one second protrusion is engaged in a corresponding fourth groove to achieve the engaged state between the first positioning portion and the third positioning portion;
the at least one second protrusion is two second protrusions, the at least one third groove is two third grooves, and the at least one fourth groove is two fourth grooves; the two second protrusions are disposed on opposite sides of the first axis, the two third grooves are disposed on opposite sides of the first axis, and the two fourth grooves are disposed on opposite sides of the first axis;
each second protrusion has two first side walls, and a distance between the two first side walls narrows from a bottom end to a top end of the second protrusion; during a process where the first clamping member rotates into or out of the second position relative to the bearing body, the first clamping member slides over the first side walls; during a process where the first clamping member rotates into or out of the first ready-to-clamp position relative to the bearing body, the first clamping member slides over the first side walls.

26. The bearing device according to claim 1, wherein in a case where the first clamping member is at the second position relative to the bearing body and the magnetic member magnetically attracts the electronic terminal, the first clamping member and the bearing body are disposed on a same side of the electronic terminal.

27. The bearing device according to claim 1, wherein the bearing body has a first peripheral wall corresponding to each first clamping member, and the bearing body has a first peripheral space adjacent to the first peripheral wall; the first clamping member comprises a rotating connection portion and a first clamping portion, wherein the rotating connection portion is rotatably arranged on the bearing body, the first clamping portion is arranged on the rotating connection portion, and the first clamping portion is rotatably arranged on the bearing body; the first clamping portion is configured to clamp the electronic terminal, and in a case where the first clamping member is at the second position relative to the bearing body, the first clamping portion is disposed in the first peripheral space of the bearing body.

28. The bearing device according to claim 27, wherein in a case where the first clamping member is at the second position relative to the bearing body, the first clamping portion is stacked on the first peripheral wall;
the first clamping portion has a first abutting wall; in a case where the first clamping portion clamps the electronic terminal, the first abutting wall abuts against the electronic terminal; in a case where the first clamping member is at the second position relative to the bearing body, the first abutting wall is close to or attached to the first peripheral wall of the bearing body.

29. The bearing device according to claim 28, wherein the rotating connection portion is rotatably arranged on the bearing body about a first axis;
the first peripheral wall comprises a first sub-wall and a second sub-wall, and the first sub-wall and the second sub-wall are disposed on opposite sides of the first axis;
in a case where the first clamping member is at the second position relative to the bearing body, the first abutting wall is capable of being close to or attached to the first sub-wall of the bearing body, or the first abutting wall is capable of being close to or attached to the second sub-wall of the bearing body.

30. The bearing device according to claim 28, wherein the rotating connection portion is rotatably arranged on the bearing body about a first axis, and the rotating connection portion is elastically retractable relative to the bearing body in a direction parallel to the first axis;
the first abutting wall is adapted to the first peripheral wall, and in a case where the first clamping member is at the second position relative to the bearing body, the first abutting wall is attached to the first peripheral wall.

31. The bearing device according to claim 28, wherein both the two clamping members are the first clamping members, a first plane perpendicular to a clamping direction of the two clamping members is defined, and the first plane is disposed between the two clamping members;
in a case where the first clamping member is at the first position relative to the bearing body, a bottom end of the first abutting wall is close to the bearing body, a top end of the first abutting wall is away from the bearing body, and from the bottom end to the top end of the first abutting wall, the first abutting wall gradually approaches the first plane.

32. The bearing device according to claim 1, wherein both the two clamping members are the first clamping members.

33. A terminal holder, comprising a support device and a bearing device; wherein the bearing device is arranged on the support device;
wherein the bearing device is configured to bear an electronic terminal and comprises a bearing body and two clamping members;
wherein the bearing body is arranged with a magnetic member for magnetically attracting the electronic terminal;
the two clamping members are both arranged on the bearing body, and the two clamping members are configured to cooperate to clamp the electronic terminal;
at least one of the two clamping members is a first clamping member, and the first clamping member is rotatably connected to the bearing body; in a case where the bearing device clamps the electronic terminal, the first clamping member is disposed at a first position relative to the bearing body; the first clamping member is capable of moving to a second position relative to the bearing body, and the first clamping member is capable of being maintained at the second position relative to the bearing body;
wherein, in a case where the two clamping members clamp the electronic terminal, the magnetic member is configured to magnetically attract the electronic terminal; in a case where the first clamping member is at the second position relative to the bearing body, the electronic terminal is capable of being placed on the bearing body, causing the magnetic member to magnetically attract the electronic terminal.
